(19) United States
(12) Patent Application Publication
(10) Pub. No.: US 2013/0031208 A1
(43) Pub. Date: Jan. 31, 2013

(54) Management and Provision of Interactive Content

(71) Applicants: Cory John Linton, Draper, UT (US); Sara Dansie Jones, Salt Lake City, UT (US); Jeremy Paul Petersen, Draper, UT (US); James Gabriel Lyon, Lehi, UT (US); Neil Jarman, West Jordan, UT (US); Heidi Hayes Jacobs, Rye, NY (US); Chet D. Linton, Sandy, UT (US); Curtis Wallace Linton, Salt Lake City, UT (US)

(72) Inventors: Cory John Linton, Draper, UT (US); Sara Dansie Jones, Salt Lake City, UT (US); Jeremy Paul Petersen, Draper, UT (US); James Gabriel Lyon, Lehi, UT (US); Neil Jarman, West Jordan, UT (US); Heidi Hayes Jacobs, Rye, NY (US); Chet D. Linton, Sandy, UT (US); Curtis Wallace Linton, Salt Lake City, UT (US)

(73) Assignee: SCHOOL IMPROVEMENT NETWORK, LLC, Midvale, UT (US)

(21) Appl. No.: 13/561,021

(22) Filed: Jul. 28, 2012

Related U.S. Application Data
(60) Provisional application No. 61/512,840, filed on Jul. 28, 2011.
(60) Provisional application No. 61/568,119, filed on Dec. 7, 2011.
(60) Provisional application No. 61/603,166, filed on Feb. 24, 2012.
(60) Provisional application No. 61/648,691, filed on May 18, 2012.

(51) Int. Cl. G06F 15/16

(52) U.S. Cl. 709/217

(57) ABSTRACT

Various implementations for managing and providing interactive content are described. One example implementation includes a system having one or more processors, a communication unit, a content management engine, an interactivity module, and a reporting module. The communication unit sends and receives data over a network. The content management engine transmits a first instance of an interactive content dataset via the communication unit to a first client device of a first user for presentation. The interactivity module receives event data describing an interaction with the interactive content dataset from the first client device via the communication unit. The reporting module generates a report describing the interaction by the first user with the interactive content dataset and transmits the report via the communication unit to one or more of the first client device and a second client device of a second user for presentation.

### CROSS-REFERENCE TO RELATED APPLICATIONS

This application claims the benefit under 35 U.S.C. §119(e) of U.S. Provisional Application No. 61/512,840, entitled “Systems and Methods for Interactive Reading and Writing”, filed on Jul. 28, 2011, U.S. Provisional Application No. 61/568,119, entitled “Interactive Content Management, Portfolio Management, and Content Navigation and Resource Suggestion”, filed on Dec. 7, 2011, U.S. Provisional Application No. 61/603,166, entitled “LivePlanner”, filed on Feb. 24, 2012, and U.S. Provisional Application No. 61/648,691, entitled “LiveBook/Planner Interfaces”, filed on May 18, 2012, the entire contents of each of which are incorporated herein by reference.

### BACKGROUND

1. Technical Field

The present disclosure relates to electronic communication. In particular, the present disclosure relates to the management and provision of interactive content.

2. Description of Related Art

Use of electronic media, such as electronic books, has grown in popularity in recent years. However, when used as a learning tool, the current electronic books and media are limited in providing a way to engage users to provide feedback and facilitate discussion and debate among users. Some of these users may reside in remote locations and wish to conveniently discuss and debate the content of an electronic book, but may be limited due to the book's lack of collaborative features. Also, in some educational or professional settings, users may be required to obtain professional or educational credit for maintaining their licensure. In some cases, users can obtain a professional or educational credit for reading a certain book. However, current approaches are limited in providing a convenient way for the user to establish that he or she read the book and qualified for the credit.

Additionally, in recent years, some educational and professional systems have been moving toward performance pay which provides that a portion of a professional's compensation may be tied to performance. For example, under some educational systems, a teacher's compensation and advancement can be tied to student achievement in the classroom and/or professional development activities. As an example of a professional development activity, a teacher may, for instance, participate in a book study where a group of teachers read a book together and collaborate in person/face-to-face on the book. However, these systems are limited in managing, monitoring, and generating a report on the teacher's professional development activities including, for example, interaction with an electronic book or a physical book (e.g., via a book study), for provision to an administrator.

### SUMMARY

Various implementations for managing and providing interactive content are described. In one innovative aspect, a system includes one or more processors, a communication unit, a content management engine, an interactivity module, and a reporting module. The communication unit sends and receives data over a network. The content management engine transmits a first instance of an interactive content dataset via the communication unit to a first client device of a first user for presentation. The interactivity module receives event data describing an interaction with the interactive content dataset from the first client device via the communication unit. The interaction reflects a learning activity being performed by the first user. The reporting module generates a report describing the interaction by the first user with the interactive content dataset and transmits the report via the communication unit to one or more of the first client device and a second client device of a second user for presentation.

In general, another innovative aspect may be embodied in methods that include transmitting a first instance of an interactive content dataset via a network to a first client device of a first user for presentation; receiving event data from the first client device via the network describing an interaction by the first user with the interactive content dataset, the interaction reflecting a learning activity being performed by the first user; generating a report describing the interaction by the first user with the interactive content dataset; and transmitting the report to one or more of the first client device of the first user and a second client device of a second user for presentation.

Other implementations of one or more of these aspects include corresponding systems, apparatus, and computer programs, configured to perform the actions of the methods, encoded on computer storage devices.

Various advantages and benefits of these implementations are described through-out this disclosure. However, the advantages and benefits are not limited thereto and other advantages and benefits are contemplated and within the scope of this disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for managing and providing interactive content.

FIG. 2 is a block diagram illustrating an example server.

FIG. 3 is a block diagram illustrating an example client device.

FIG. 4 is a flowchart of an example method for providing and managing user interaction with interactive content.

FIGS. 5A and 5B are flowcharts of another example method for providing and managing user interaction with interactive content.

FIG. 6 is a flowchart of an example method for providing and managing user interaction with corresponding interactive content.

FIGS. 7A-10B are graphic representations of example user interfaces for authoring, viewing, and interacting with interactive content.

FIGS. 11A-B are flowcharts of example methods for automatically personalizing and/or developing an interactive content dataset.

### DETAILED DESCRIPTION

### Example System Overview

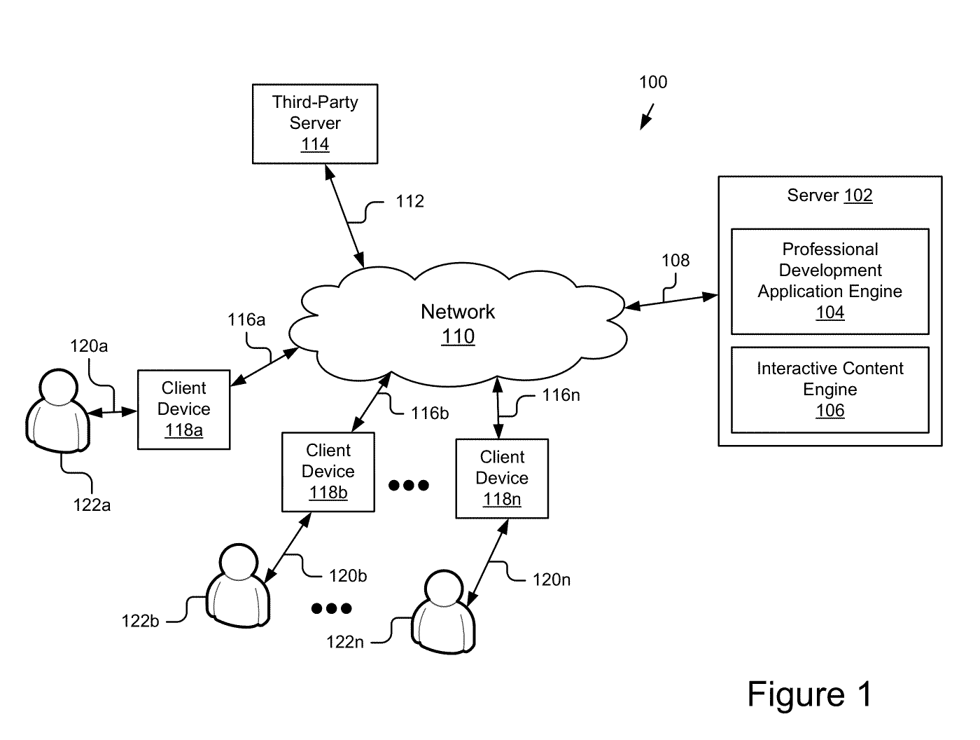

FIG. 1 is a block diagram illustrating an example system 100 for managing and providing interactive content. In the depicted embodiment, the system 100 includes a server 102, a network 110, a third-party server 114, client devices 118a, 118b . . . 118n (also referred to herein individually and collectively as 118) that are accessed by users 122a, 122b . . . 122n (also referred to herein individually and collectively as 122). In the illustrated embodiment, the entities 102, 114 and 118 are electronically communicatively coupled via the network 110. The system 100 illustrated in FIG. 1 is a representative system for managing and providing interactive content, and it should be understood that a variety of different system environments and configurations may be employed and are within the scope of the present disclosure. Other embodiments may include fewer or additional servers 102, third-party servers 114, client devices 118, and other computing devices providing services, such as email, network and web search, social networking, text messaging, information, etc. Further, while the present disclosure is described above primarily in the context of activities related to professional development and educational instruction via the server 102, it is applicable to any type of electronic communication between entities of a network.

The server 102 is a computing device or system for providing a professional development or educational service. In the depicted embodiment, the server 102 is coupled to the network 110 via signal line 108. The server 102 may include one or more processors and one or more storage devices storing data or instructions for execution by the one or more processors. For example, the server 102 may be a server, a server array or any other computing device, or group of computing devices, having data processing, storing, and communication capabilities. The server 102 may be a virtual server (i.e., a virtual machine) implemented via software. For example, the virtual server operates in a host server environment and accesses the physical hardware of the host server including, for example, a processor, memory, storage, network interfaces, etc., via an abstraction layer (e.g., a virtual machine manager). It should be understood that the server 102 may be made up of any combination of devices and servers, or only one device or server. The server 102 may interact with the other entities 114 and 118 of the system 100 via the network 110 or may be coupled to and interact with the third-party server 114 or client devices 118 directly via a direct data connection.

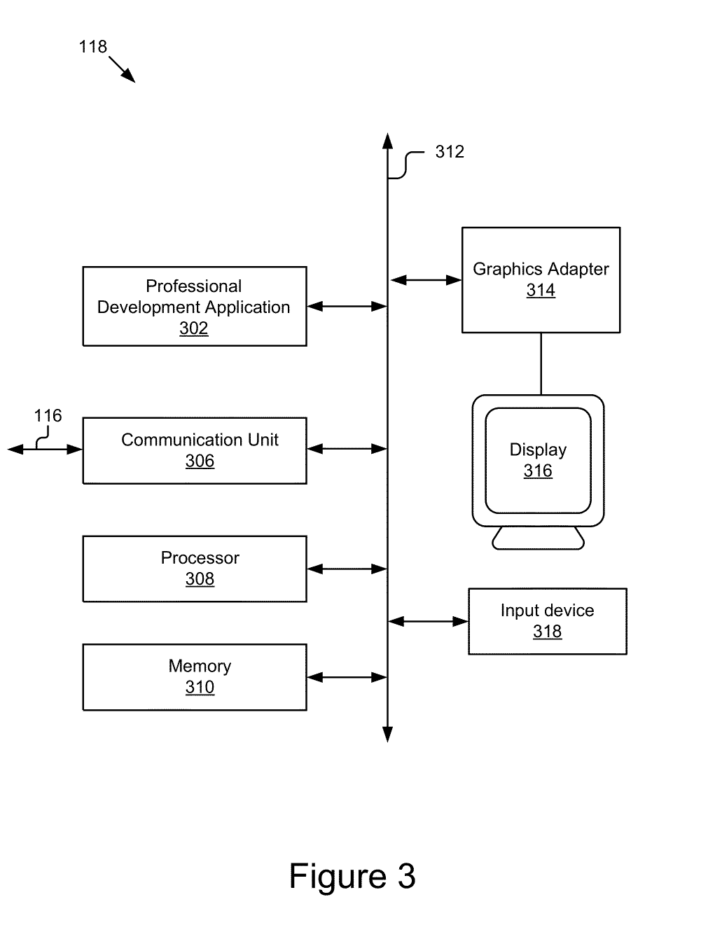

In some embodiments, the entities of the system 100 including the server 102 may be implemented using cloud-based architectures where one or more computer functions are performed by remote computing systems and devices at the request of a local computer device. For example, a client device 118 may be a computing device having a limited set of hardware and/or software resources and may access hardware and/or software resources provided across the network 110 by other computer devices and resources, such as other client devices 118, the third-party server 114, the server 102, or any other computing resources. The client device 118 may access these resources through an access program, such as a web browser, and the results of any computer functions or resources may be delivered through the access program to the user of the client device 118, such as those described below with reference to FIG. 3. The server 102 may be cloud-based distributed computing system having dynamically scalable and virtualizable resources, and various functionality of the server 102, the application engine 104, and interactive content engine 106 may be carried out and supplemented by computing systems and devices distributed over the network 110. Although only one server 102 is shown, multiple servers 102 may be included in the system 100.

In FIG. 1, the server 102 includes an application engine 104 and an interactive content engine 106. The application engine 104 is software, code, logic, or routines for providing educational instruction and professional development training to its users, such as professionals, students, etc. In some embodiments, the application engine 104 is operable on the server 102.

Professional development training includes teaching skills to participants, assisting participants in integrating and applying those skills to their profession, assessing the success of participants in applying the skills, and evaluating whether additional training is necessary. By way of example, professional development training may be used to improve the skills of teachers and school administrators, health care professionals such as nurses or physicians, legal professionals such as lawyers, judges or trustees, corporate professionals such as officers, directors, managers or other internal corporate employees, travel industry professionals such as pilots, drivers, skippers or the like, educational professionals such as teachers or professors, financial professionals such as accountants, brokers, traders, tax specialists or the like, human relations professionals, sales professionals, service industry professionals, government employees, law enforcement personnel, military personnel, sports professionals and/or personnel, homeland security personnel, or any other workforce that requires professional training and assessment as to the assimilation and effectiveness of such training.

In some embodiments, the services (e.g., professional development training, educational instruction, etc.) may be provided by the application engine 104 via the network 110 to users (e.g., teachers, administrators, students, etc.) in an academic environment or other educational setting, such as a school district. In cooperation with the client application 302 (see FIG. 3), the application engine 104 may provide these users access to a wide range of resources such as publications, audio or video resources, lesson plans, planning tools, community discussion and sharing tools, industry standards, progress monitoring tools, reporting tools, etc. These resources may describe various topics of interest, such as leadership training, math skills, communication skills, English skills, and similar subjects of consequence and importance to the professional development of educational instructors. These resources may be provided real-time via the Internet by the application engine 104. For example, a user 122 may use navigation or search functionality of the application engine 104 to find relevant resources, and upon selection of a particular resource, the application engine 104 may retrieve and transmit the resource (e.g., by streaming audio and/or video) to the client device 118 of the user 122 for presentation to the user 122.

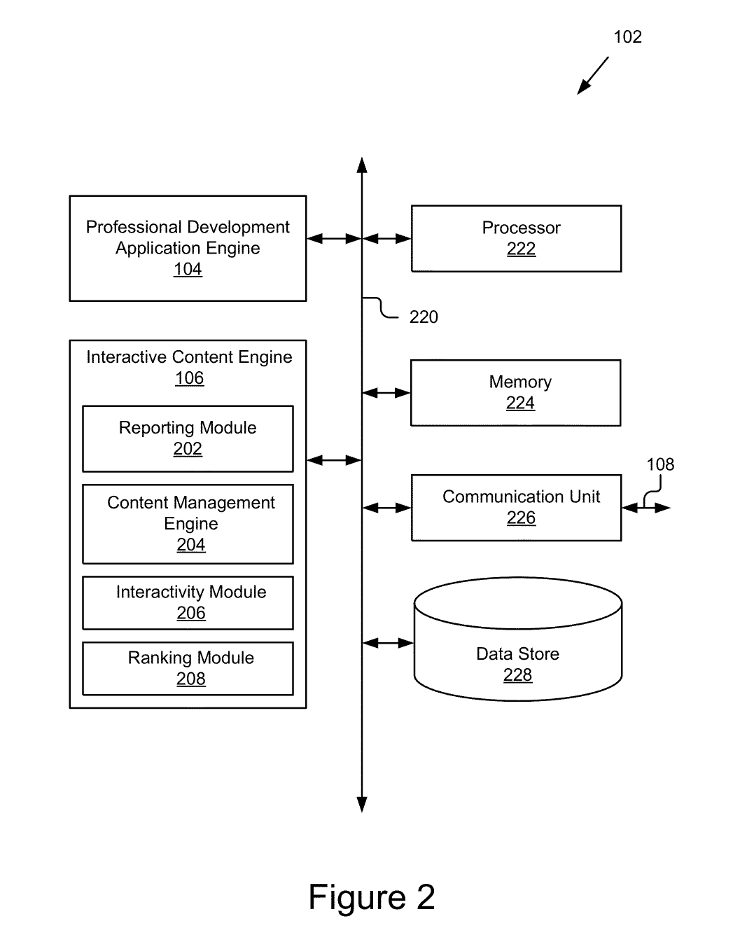

The interactive content engine 106 is software, code, logic, or routines for managing interactive content including monitoring user interaction with the interactive content and reporting on the user interaction. In some embodiments, the interactive content engine 106 is operable on the server 102. In other embodiments, the interactive content engine 106 is operable on a client device 118. While FIG. 1 only illustrates the server 102 as including the interactive content engine 106, in practice, any of the depicted devices, such as the client devices 118 and the third-party server 114 could include the interactive content engine 106. While various example embodiments are described herein within the context of professional development, it should be understood that the dynamic, collaborative, and interactive experience that the interactive content engine 106 provides is not limited to the professional development environment. Rather, interactive content engine 106 and the interactive content datasets provided thereby can facilitate communication, collaboration, feedback, and interaction between any related parties including author(s) and reader(s); administrator(s) and teacher(s); teacher(s) and student(s); administrator(s) and student(s); coach(es) and coachee(s); mentor(s) and mentee(s); student(s) and student(s), etc. Additional structure and functionality of the interactive content engine 106 are described herein, for example, with reference to FIGS. 2-6 and 11A-B.

The network 110 is wired or wireless network and may have any number of configurations such as a star configuration, token ring configuration or other known configurations. The network 110 may include a local area network (LAN), a wide area network (WAN) (e.g., the Internet), and/or any other interconnected data path across which multiple devices may communicate. The network 110 may be coupled to or include a mobile (cellular) network including distributed radio networks and a hub providing a wireless wide area network (WWAN), or other telecommunications networks. In some embodiments, the network 110 may include Bluetooth® communication networks for sending and receiving data. The network 110 may transmit data using a variety of different communication protocols including user datagram protocol (UDP), transmission control protocol (TCP), hypertext transfer protocol (HTTP), hypertext transfer protocol secure (HTTPS), file transfer protocol (FRP), dynamic adaptive streaming over HTTP (DASH), real-time streaming protocol (RTSP), real-time transport protocol (RTP) and the real-time transport control protocol (RTCP), direct data connection, wireless access protocol (WAP), various email protocols, etc. Client devices 115 may couple to and communicate via the network 110 using a wireless and/or wired connection. In some embodiments, the client devices 118 include a wireless network interface controller for sending and receiving data packets to an access point of the network 110. For example, the client devices 118 may be Wi-Fi™ enabled devices which connect to wireless local area networks (WLANs), such as wireless hotspots, included in the network 110. The client devices 118 may also include one or more wireless mobile network interface controllers for sending and receiving data packets via a WWAN of the network 110.

The third-party server 114 is a computing device or system for providing various computing functionalities, services, and/or resources to the other entities of the system 100. In some embodiments, the third-party server 114 is a server hosting a network-based software application operable to provide the computing functionalities, services and/or resources or functionalities, and to send data to and receive data from the server 102 and the client devices 118a, 118b . . . 118n via the network 110. The third-party server 114 is coupled to the network 110 via signal line 112. In some embodiments, the third-party server 114 is a server, server array or any other computing device, or group of computing devices, having data processing, storing and communication capabilities. For example, the third-party server 114 may provide one or more services including professional development, internet searching; social networking; web-based email; blogging; micro-blogging; photo management; video, music and multimedia hosting, distribution, and sharing; business services; news and media distribution; access to core text content; or any combination of the foregoing services. It should be understood that the third-party server 114 is not limited to providing the above-noted services and may include any other network-based or cloud-based service. For simplicity, a single block for the third-party server 114 is shown. However, in other embodiments, several distinct third-party servers (not shown) may be coupled to the network via distinct signal lines to provide distinct or competing services. The third-party server 114 may require users to be registered and authenticate to use various functionality provided by the third-party server 114.

In some embodiments, the third-party server 114 can provide access to data that is associated with users of the application engine 104 and interactive content engine 106. In some embodiments, the third-party server 114 may store and provided access to demographics data, achievement data, student data, teacher data, standards data, etc., and the third-party server 114 may include a software application for providing secure access to this data to the application engine 104 over the network 110 via an API. For example, in an educational setting, the demographics data may include instructor and pupil demographics data, and may be segmented across school district, school, classroom, grade, etc.; the achievement data may include standardized test scores for educators and pupils; the student data may include student assessments of teachers (e.g., aggregated from surveys, reviews, etc.), biographical data describing the students, social graph data (e.g., aggregated from third-party social networking services), etc.; the teacher data may include biographical data describing the teachers, social graph data (e.g., aggregated from third-party social networking services), teacher preferences, teacher assessments of students (e.g., aggregated from surveys, reviews, etc.), etc.; and the standards data may include standards compiled and approved by a governing organization or institution which define the levels of attainment pupils much reach to be considered acceptably educated. In some embodiments, the data provided by the third-party server 114 may be collected (e.g., at regular intervals) by an aggregator (not shown) of the interactive content engine 106 and/or the application engine 104 and stored in the data store 228 (see FIG. 2).

The client devices 118a, 118b . . . 118n are computing devices having data processing and data communication capabilities. In some embodiments, the client device 118a is coupled to the network 110 via signal line 116a, and the user 122a interacts with the client device 118a as depicted by line 120a; the client device 118b is coupled to the network 110 via signal line 116b, and the user 122b interacts with the client device 118b as depicted by line 120b; and the client device 118n is coupled to the network 110 via signal line 116n, and the user 122a interacts with the client device 118n as depicted by line 120n.

In some embodiments, the client device 118 is a handheld wireless computing device which is capable of sending and receiving voice and data communications. For example, the client device 118 may include a processor, a memory, a power source, and a communication unit including one or more wired or wireless network interfaces for interacting with the network 110. For example, the communication unit may include wireless transceivers to broadcast and receive network data via radio signals. The client device 118 may also include one or more of a graphics processor; a high-resolution touchscreen; a physical keyboard; forward and rear facing cameras; sensors such as accelerometers and/or gyroscopes; a GPS receiver; a Bluetooth® module; memory storing applicable firmware; and various physical connection interfaces (e.g., USB, HDMI, headset jack, etc.); etc. Additionally, an operating system for managing the hardware and resources of the client device 118, application programming interfaces (APIs) for providing applications access to the hardware and resources, a user interface module for generating and displaying interfaces for user interaction and input, and applications such as applications for making phone calls, video calls, web browsing, messaging, social networking, gaming, capturing digital video and/or images, etc., may be stored and operable on the client device 118. In some embodiments, a client device 118 includes a workstation computer, a desktop computer, a laptop computer, a netbook computer, a tablet computer, a smartphone, a set-top box/unit, an Internet Protocol-connected smart TV including a computer processor capable of receiving viewer input, accessing video content on computer networks such as the Internet, and executing software routines to provide enhanced functionality and interactivity to viewers, or the like. In other embodiments, different client devices 118a, 118b . . . 118n are different types of computing devices. For example, the client device 118a is a laptop, the client device 118b is a smart phone, and the client device 118n is a tablet computer. While FIG. 1 illustrates three or more client devices, the present disclosure applies to any system architecture having one or more client devices. Additional structure and functionality of the client devices 118 are described below with reference to at least FIG. 3.

### Example Server 102

FIG. 2 is a block diagram of a server 102 according to some embodiments. In the depicted embodiment, the server 102 is a computing device that includes the application engine 104, the interactive content engine 106, a processor 222, a memory 224, a communication unit 226, and a data store 228, which are communicatively coupled via a communication bus 220. In various implementations, the application engine 104, the interactive content engine 106, its respective sub-components 202, 204, 206, and 208, etc., may be sets of instructions stored in the memory 224 and executable by the processor 222 for communication with the other components of the server 102; may be implemented via one or more application specific integrated circuits (ASICs) coupled to the bus 220 for cooperation and communication with the other components of the server 102; sets of instructions stored in one or more discrete memory devices (e.g., a PROM, FPROM, ROM) that are coupled to the bus 220 for cooperation and communication with the other components of the server 102; a combination thereof; etc.

The bus 220 can include a conventional communication bus for transferring data between components of a computing device or between computing devices, a network bus system including the network 110 or portions thereof, a processor mesh, a combination thereof, etc. In some implementations, the application engine 104, the interactive content engine 106 and its sub-components 202, 204, 206, and 208, and various software operating on the server 102 (e.g., an operating system) may cooperate and communicate via a software communication mechanism implemented in association with the bus 220. The software communication mechanism can include and/or facilitate, for example, inter-process communication, local function or procedure calls, remote procedure calls, an object bus (such as CORBA), direct socket communication (such as TCP/IP sockets) among software modules, UDP broadcasts and receipts, HTTP connections, etc. Further, any or all of the communication could be secure (SSH, HTTPS, etc.).

The server 102 depicted in FIG. 2 is provided by way of example and it should be understood that the server 102 may take other forms and include additional or fewer components without departing from the scope of the present disclosure. For example, while not shown, in some implementations, the server 102 may include input and output devices (e.g., a computer display, a keyboard and mouse, etc.), various operating systems, sensors, additional processors, and other physical configurations. Additionally, it should be understood that the computer architecture depicted in FIG. 2 is applicable to the other entities of the system 100 with various modifications. For example, the third-party server 114 could have the same or a similar architecture as the server 102 depicted in FIG. 2, including, for instance, a processor 222, a memory 224, a communication unit 226, and a data store 228 coupled via a bus 220.

The processor 222 includes an arithmetic logic unit, a microprocessor, a general purpose controller, or some other processor array to perform computations and provide electronic display signals to a display device (not shown). The processor 222 may be coupled to the bus 220 for communication with the other components of the server 102. The processor 222 may process data signals and may have various computing architectures including a complex instruction set computer (CISC) architecture, a reduced instruction set computer (RISC) architecture, or an architecture implementing a combination of instruction sets. Although only a single processor 222 is shown in FIG. 2, multiple processors may be included and each processor may include a single processing core or multiple interconnected processing cores. The processor 222 may be capable of supporting the display of images and the capture and transmission of images, perform complex tasks, including various types of feature extraction and sampling, etc.

The memory 224 stores instructions and/or data that may be executed by the processor 222. For example, the memory 224 can store the application engine 104 and the interactive content engine 106. The memory 224 is also capable of storing other instructions and data such as an operating system, hardware drivers, other software applications, databases, etc. The memory 224 is coupled to the bus 220 for communication with the processor 222 and the other components of server 102. The instructions and/or data may comprise code for performing any and/or all of the techniques described herein. In particular, the memory 224 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 222. A non-transitory computer-usable storage medium may include any and/or all computer-usable storage media. In some implementations, the memory 224 may include volatile memory, non-volatile memory, or both. For example, the memory 224 may include one or more of a dynamic random access memory (DRAM) device, a static random access memory (SRAM) device, flash memory, a hard disk drive, a floppy disk drive, a CD ROM device, a DVD ROM device, a DVD RAM device, a DVD RW device, a flash memory device, and any other mass storage device known for storing information on a more permanent basis. It should be understood that the memory 224 may be a single device or may include multiple types of devices and configurations.

The communication unit 226 is coupled to the network 110 by the signal line 108 and coupled to the bus 220. In some embodiments, the communication unit 226 includes network interface devices (I/F) for wired and wireless connectivity with the network 110. For example, the communication unit 226 may include a CAT-5 interface, USB interface, or SD interface, transceivers for sending and receiving signals using Wi-Fi™, Bluetooth® or cellular communications for wireless communication, etc. The communication unit 226 can link the processor 222 to the network 110 that may in turn be coupled to other processing systems. The communication unit 226 can provide other connections to the network 110 and to other entities of the system 100 using standard communication protocols including, for example, TCP/IP, HTTP, HTTPS, SMTP, etc.

### Example Interactive Content Engine 106

The interactive content engine 106 is software, code, logic, or routines for managing interactive content, monitoring user interaction with the interactive content and reporting on the user interaction. The interactive content engine 106 provides users 122 a platform for individual and/or cross-linked interactive content datasets from a content catalog or library, reading and interacting with the content of the datasets provided by the interactive content engine 106, and producing work-product based on their consumption/interaction with the content. For example, the interactive content engine 106 may provide functionality for authoring and revising interactive content, tracking user interaction with interactive content, providing tasks/assignments in an interactive content dataset, generating work product from the tasks/assignments completed by a user, sharing uploaded work product with other users, managing and grading the work-product/completed assignments, generating and distributing reports summarizing user interaction, etc.

The interactive content engine 106 may cooperate with the application engine 104 to provide social network functionality to the users 122. In some embodiments, the application engine 104 may collect and store mapping information (i.e., a social graph) mapping how all users 122 of the application engine 104 and interactive content engine 106 are associated, and the interactive content engine 106 may access this information to provide content customized for each user 122. For example, the social graph may describe any particular user's 122 relationships with other users 122, based at least in part on shared attributes, etc. In another example relating to educational professionals, all users 122 may be associated by school, school district, subject matter taught, amount of experience, etc. Users may also define their own connections using functionality provided by the client application 302 in cooperation with the application engine 104 and/or the interactive content engine 106. For example, users 122 who met at a math conference may add one another to their respective social graphs by using functionality provided by the client application 302 in cooperation with the application engine 104 and/or the interactive content engine 106.

In the depicted embodiment, the interactive content engine 106 includes a reporting module 202, a content management engine 204, an interactivity module 206, and a ranking module 208. The components 202, 204, 206 and 208 of the interactive content engine 106, and the interactive content engine 106 itself, are coupled for communication with each other and the other components 104, 222, 224, 226 and 228 of the server 102. In some embodiments, the interactive content engine 106 interacts and communicates with the application engine 104 via the processor 222. For example, the interactive content engine 106 can interact with a credentials module (not shown) of the application engine 104 to authenticate users 122 seeking access to the interactive content engine 106, and to provide the interactive content engine 106 access to information and functionality of the application engine 104. In other embodiments, the interactive content engine 106 is stored and operable on a third-party server (not shown) which is coupled by the network 110 for communication and interaction with the server 102 and the application engine 104. In these or other embodiments, the interactive content engine 106 may access information and utilize the functionality of the application engine 104 via an API. In yet other embodiments, the application engine 104 and the interactive content engine 106 may be integrated. Other embodiments further segmenting or combining various elements of the application engine 104 and the interactive content engine 106 are also contemplated.

Interactive content datasets may include any digital content or media type including data describing text, images, video, audio, documents, polls, surveys, bookmarks, outlines, comments, forum threads, user shares, etc. For example, an interactive content dataset may be an electronic book with functionality for readers to add comments, share passages, promote forum discussions, provide feedback to the author, bookmark passages, complete coursework and lesson plans, create an implementation plan, produce other work product, upload and attach files, etc., and for authors to revise the interactive content with new content, and make changes to existing content based on the interaction of the readers with the content. In some embodiments, the content of a dataset text is fully customizable and editable by the author(s), and the author(s) can collaborate with a community of readers, thus making the readers' interaction with the dataset dynamic and fulfilling.

By way of example, an interactive content dataset may serve as a textbook for a particular class/subject. In some embodiments, the interactive content dataset may be authored/customized (e.g., by the original author, an instructor, etc.) to include tasks/assignments for that class/subject. In other embodiments, the interactive content dataset may include standardized tasks/assignments for completion by the readers/users. In yet other embodiments, the dataset may include both custom and standardized tasks/assignments. By way of example, the interactive content dataset may include functionality for the users to download and/or upload assignments. For instance, the users may download a document including questions about a particular topic, and may be required to edit the document using a word processor to provide answers to those questions and then upload/attach the edited document (i.e., work-product) in order to successfully complete their assignments. In another example, the interactive content dataset may include fields, such as check boxes, text-entry boxes, radio-dialogs, etc., for the users to use to input information with about various topics, and once completed, the information may be transmitted from the users' client devices 118 to the interactivity module 206 and recorded in the datastore. In yet other examples, to complete assignments, the users may be required to complete surveys, collaborate and/or share information with other users, complete tasks described by the dataset and upload evidence of the completion thereof (e.g., video, audio, documents, etc.).

The interactivity module 206 may track the completion of the tasks/assignments on a per-user basis, or per aggregated user basis (e.g., by group, school, district, state, or any other aggregated group). For example, the interactivity module 206 may store record of the assignments/tasks completed by each user, and the reporting module 202 may generate and provide a summary of the completed/uncompleted assignments/tasks to an instructor, administrator, supervisor of the users, or the like. In some embodiments, the reporting module 202 may provide functionality, in cooperation with the client application 302, for an instructor to grade the assignments/tasks completed by the users. For example, an instructor may input grades for the completed assignments/tasks via an interface presented by the client application 302, and the client application 302 may transmit those grades to the interactive content engine 106 via the network 110 for storage in the data store 228. In other examples, the interactivity module 206 or the reporting module 202 may automatically grade the assignments/tasks using predefined answers stored in the data store 228. At the end of a grading period, the instructor may request a grade report for a class and/or subject, and the reporting module 202 may generate and send a summary of the grades for the assignments/tasks completed by the instructor's pupils in association with the dataset.

In some embodiments, an author may create multiple interactive content datasets which correspond. For example, the content of the datasets may be directed to the same topic and may redirect users between the datasets to additional content and resources on a particular subject, etc. In some embodiments, the datasets may be cross-linked via links embedded in the text of the datasets. These datasets may be linked in any fashion. For example, links embedded in the text of one dataset may redirect a user to accompanying sections of another dataset. The datasets may also contain corresponding sections which can be viewed, interacted with, and navigated simultaneously in a multiple region/column interface, or via multiple interfaces.

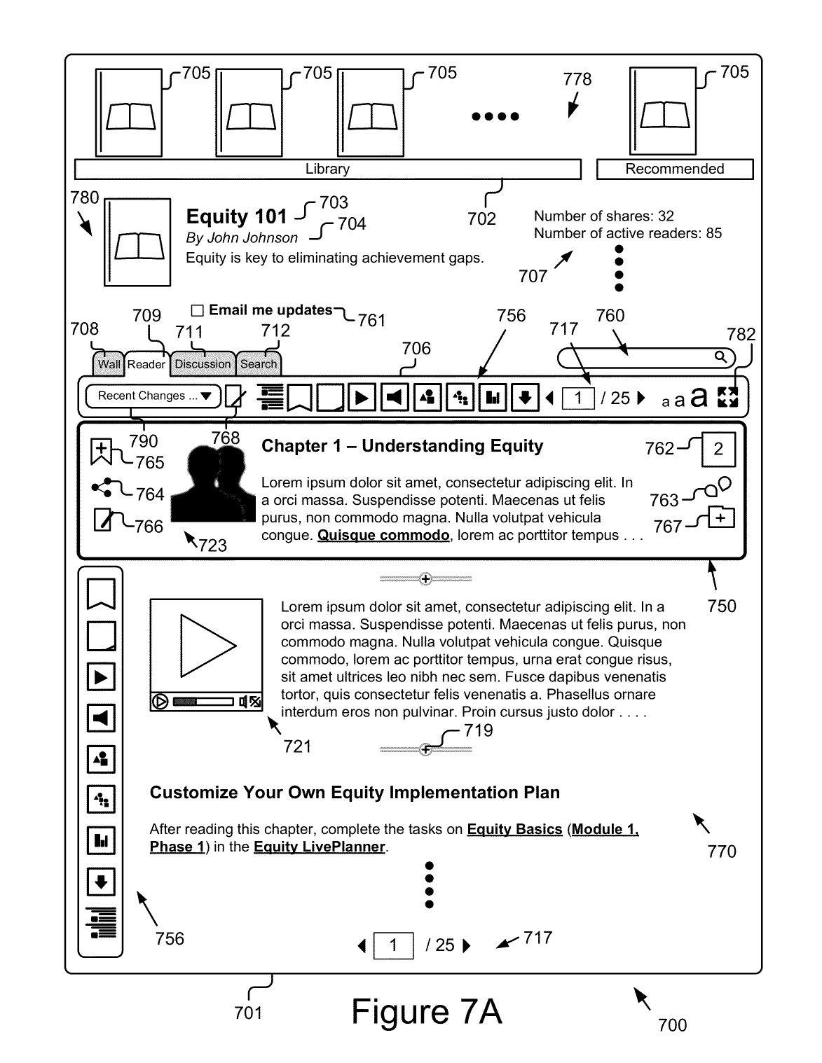

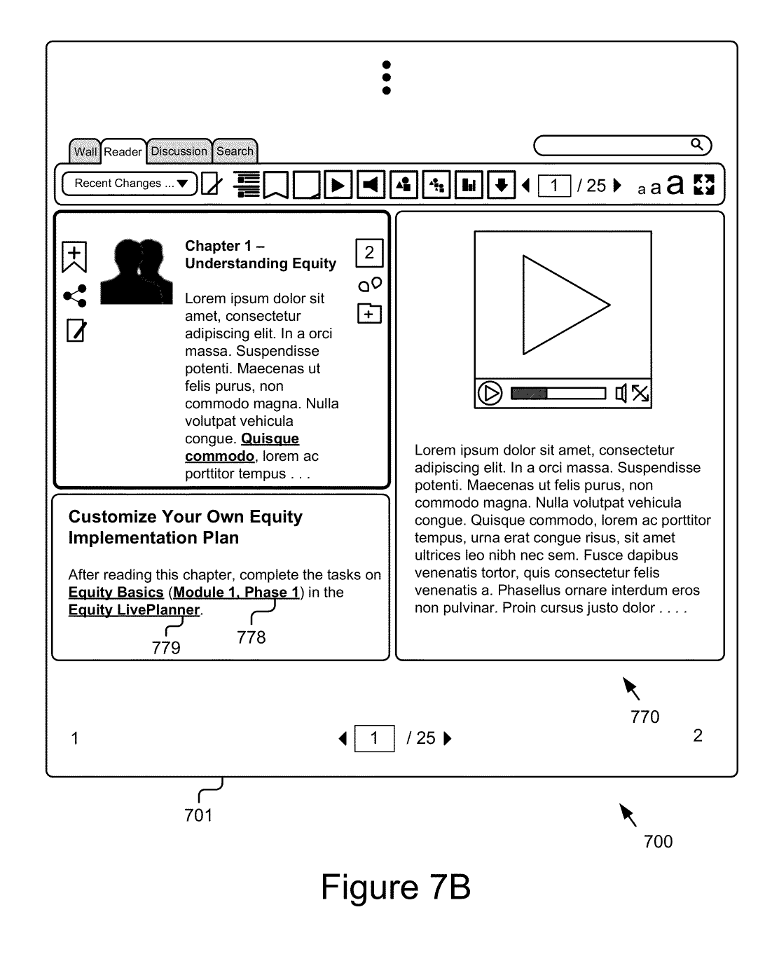

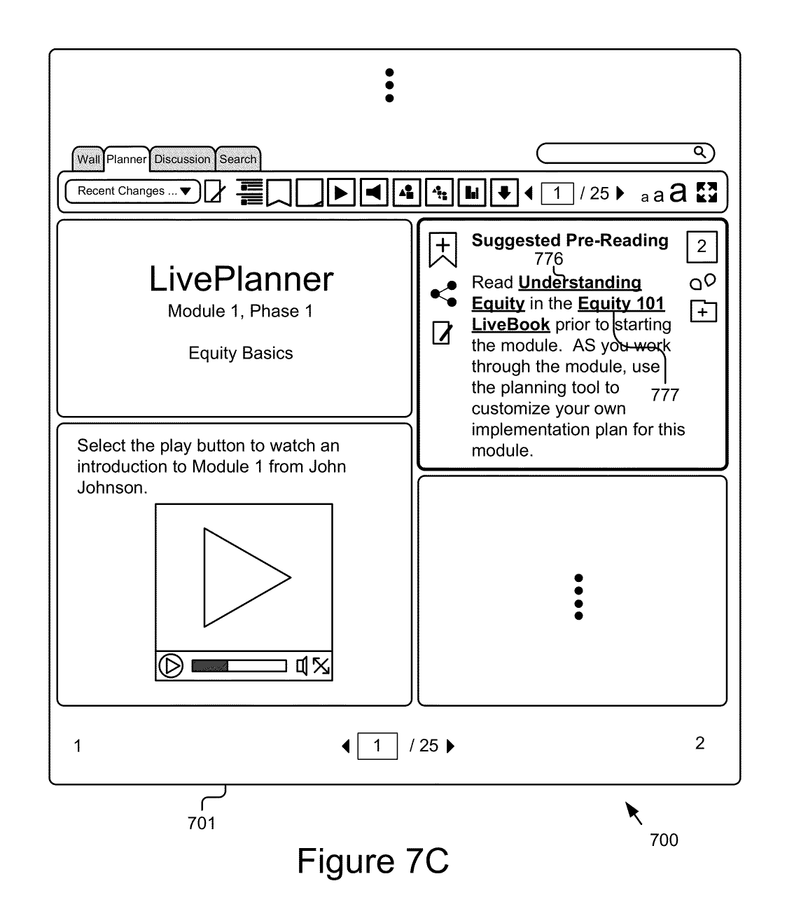

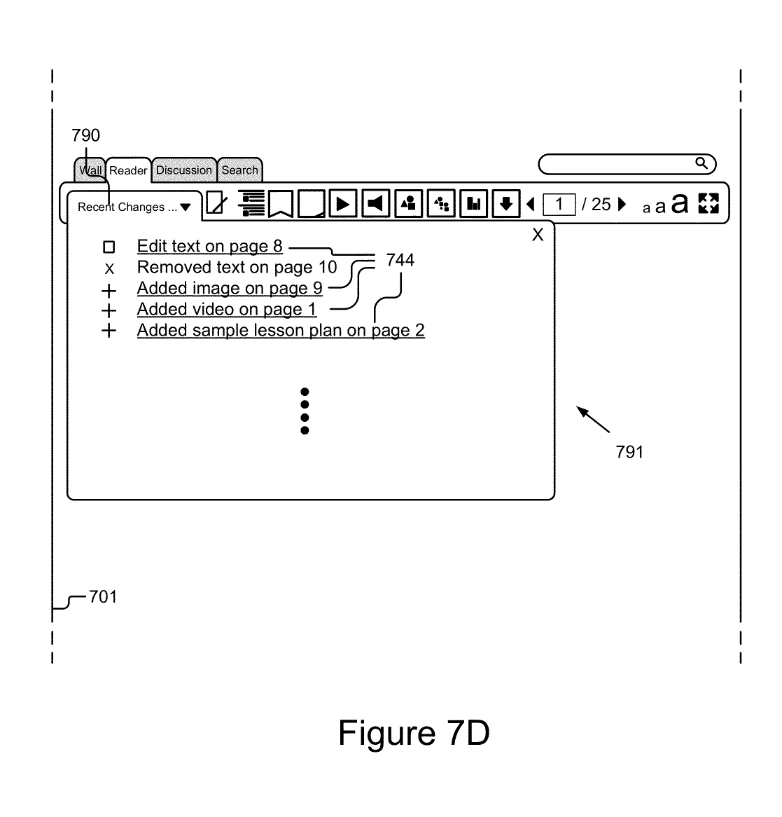

By way of example, one interactive content dataset may serve as a scholarly reference while another interactive content dataset may be a practical reference that includes specific tasks for users 122 to complete. The practical reference could provide tasks for creating a lesson plan on a subject expounded upon by the scholarly reference, and then redirect the user 122 back to the scholarly reference via an embedded link upon completion of the tasks. For example, FIG. 7B depicts the scholarly reference (i.e., a first interactive content dataset) which expounds upon a particular subject. FIG. 7C depicts the practical reference (i.e., a second interactive content dataset) which includes tasks for creating an implementation plan to implement the theory taught by the scholarly reference. In this example, the second interactive content dataset depicted in FIG. 7C includes electronic links 776 and 777 which link to corresponding sections of the first interactive content dataset depicted in FIG. 7B, and the first interactive content dataset depicted in FIG. 7B includes electronic links 778 and 779 which link to the corresponding sections depicted of the second interactive content dataset depicted in FIG. 7C. In some embodiments, the cross-linked interactive content datasets are akin to an online course, where one dataset serves as the textbook and one dataset serves as the coursework, and completion of the coursework provides practical usable work product, such as a lesson plan, which can be used by a user 122 in his or her profession. In other embodiments, the work-product produced by completing of the tasks in the second interactive content dataset, or a report summarizing the completion of these tasks, can be provided to an accrediting body in exchange for educational credit.

In a further example, a first interactive content dataset is an interactive e-book that gives a group of educators the theory, research, and case studies behind curriculum integration. The interactive functionality of the first interactive content dataset, as described herein, supports and online community of educators and enables collaboration between those educators across school district and geographic borders. The corresponding second interactive content dataset is a personal workshop that turns the theory of the first interactive content dataset into practice. This second interactive content dataset provides the same or similar interactive functionality of the first interactive content dataset while also providing educators functionality to create their own personalized curriculum map. For example, the second interactive content dataset includes step-by-step instructions and tools to successfully create customized maps for aligning the educators' practice with the educational standards of their respective districts, states, countries, etc. In various embodiments, the interactions with the first and second interactive content datasets may be shared between and made available to the educators interacting with them, or may be segmented between the datasets (e.g., by the interactivity module 206). It should be understood that while examples and embodiments involving two corresponding datasets are described, any number of datasets may correspond and be interlinked, and systems and methods for authoring and facilitating user interaction with those datasets are contemplated and fall within the scope of the present disclosure.

The reporting module 202 is software, code, logic, or routines for generating and sending reports. In some embodiments, the reporting module 202 is a set of instructions executable by the processor 222 to provide this functionality. In other embodiments, the reporting module 202 is stored in the memory 224 of the server 102 and is accessible and executable by the processor 222 to provide this functionality. In any of these embodiments, the reporting module 202 may be adapted for cooperation and communication with the processor 222 and other components of the server 102.

The reporting module 202 may analyze user behavior in interacting with an interactive content dataset or corresponding datasets and generate reports summarizing and/or detailing this analysis. For example, when a user accesses an interactive content dataset, pages through the interactive content dataset, downloads files included with or embedded in the interactive content dataset, completes surveys included with the interactive content dataset, views videos embedded in the interactive content dataset, comments on passages of the interactive content dataset, completes tasks associated with a dataset, performs gestures in association with the dataset, or otherwise uses any other functionality provided by the client application 302 (e.g., see FIG. 3) for interaction with the dataset, the corresponding components of the interactive content engine 106, such as the content management engine 204, the interactivity module 206 or the ranking module 208 store event data describing the interaction in the data store 228, and the reporting module 202 accesses the event data to analyze user interaction and generate reports describing the user interaction.

In some embodiments, the reporting module 202 generates a report in response to receiving a report instruction. The report instruction may be automatically generated and provided by the interactive content engine 106 at certain intervals, times, etc., may be received remotely via an application programming interface API of the interactive content engine 106, may be provided by the client application 302 of the client device 118, etc. For example, the user 122 of the client device 118 may input a command into the client device 118 via the client application 302 commanding that a report be generated describing that user's 122 activity with the interactive content of one or more datasets. Responsive to receiving the command, the client application 302 may generate and send a report instruction via the network 110 instructing the reporting module 202 to generate the report based at least in part on the command input by the user 122, and the reporting module 202 generates the report accordingly. In another example, a user 122 who authored the interactive content may instruct, via the client application 302, that a report be generated by the reporting module 202 describing user interactions with the content authored by the user 122. In yet another example, the reporting module 202 may autonomously generate the report, for example, at regular intervals. In some embodiments, the reporting module 202 may transmit the report to the client application 302 for display to the user 122, provide the report for download as a portable document, transmit (e.g., via email) the report to one or more other users 122 designated by the instruction instructing the reporting module 202 to generate the report, etc.

The reporting module 202 provides a number of advantages including allowing a user 122 to provide a report evidencing the user 122's activity with the interactive content to an administrator or instructor for verification thereof. By way of example, many professions require members to acquire a certain number of educational credits to remain certified or licensed as professionals. Often the educational credits are acquired by completing educational programs. The reporting module 202 provides a convenient way to report user interaction with interactive content provided by the interactive content engine 106 to establish that sufficient interaction with the interactive content was undertaken to qualify for credit. While the present disclosure describes various embodiments in the context of professional development, the examples discussed herein are applicable to any learning or training environment. For example, an interactive content dataset may serve as a textbook or a required reading for a class/subject being taught in an educational system (e.g., primary, secondary, executive, etc.) and may include gradable tasks/assignments for completion by the students/users of that class/subject. The instructor(s) of these students can interact with the reporting module 202 (e.g., via the client application 302) to manage the tasks, activities, assignments, etc., that are included in the datasets, as discussed further below.

In one example, a first interactive content dataset may be an interactive electronic book on a particular subject (e.g., math, classroom management, etc.) and a second interactive content dataset may be an interactive electronic book having practical activities/tasks embedded therein (e.g., video segments, written assignments, questions, surveys, etc.). These first and second datasets may include corresponding sections on various aspects of that subject that are electronically cross-linked via user-selectable elements, and the user 122 can navigate between these datasets to study the content provided and complete the assigned activities/tasks. Event data describing what portions of the content the user has navigated, interacted with, input, completed, etc., is received from the client device of the user and stored in the datastore 228, and the reporting module 202 can generate and provide a report describing the user's interaction with the first and second datasets, including, for example, what tasks the user has completed, sections he/she has read, etc.

Another advantage provided by the reporting module 202 is establishing a robust feedback loop for the user or users authoring various interactive content via the interactive content engine 106. For example, an author may generate a report including comments on certain sections of the interactive content, user rankings of the interactive content, information describing how users are interacting with the interactive content, forum discussions on the interactive content, statistics on how the interactive content is being shared between users, etc. which may prompt additions or revisions to the interactive content. Various examples of user interfaces for presenting these datasets and various dialogs for interacting with the datasets are described below with reference to at least FIGS. 7A-10B.

The content management engine 204 is software, code, logic, or routines for managing the authoring and provision of interactive content. In some embodiments, the content management engine 204 is a set of instructions executable by the processor 222 to provide this functionality. In other embodiments, the content management engine 204 is stored in the memory 224 of the server 102 and is accessible and executable by the processor 222 to provide this functionality. In these or other embodiments, the content management engine 204 may communicate/interact with a third-party content management system (e.g., included in/operated by the third-party server 114) to facilitate provision of the content, which is stored by that third-party system, available to client devices 118. For example, the content management engine 204 may receive the content directly from the third-party content management system and relay it to a client device 118, or may enable the client device 118 to receive the content directly from the third-party management system. In this example, the content management engine 204 may or may not store the content locally. In any of these embodiments, the content management engine 204 may be adapted for cooperation and communication with the processor 222 and other components of the server 102 via the bus 220. For example, the content management engine 204 is coupled to communication unit 226 to send and receive data via the network 110 to the other entities of the system 100, and is coupled to the data store 228 for storing, manipulating, and retrieving data.

In some embodiments, the content management engine 204 may maintain a library of interactive content datasets spanning any number of themes, topics, purposes, and subjects. For example, the library may include interactive publications such as electronic books, textbooks, periodicals, journals, etc. In a further example, the library is a dynamic resource library that provides tools and information from leading experts on the most relevant/important topics. Additionally, the library maintained by the content management engine may be a dynamic resource library providing access to fiction and non-fiction books. The content management engine 204 may receive a catalog request requesting a listing of some or all of the interactive content datasets included in the library. The catalog request may request a listing of a recommended interactive content dataset related to a particular topic or matching certain metadata. For example, if the interactive content dataset being viewed by a user 122 on the client device 118 via the client application 302 is an electronic book on how to teach fourth grade mathematics, the client application 302 could send a request for other interactive content (e.g., interactive electronic books) that include metadata matching teaching the fourth grade generally, or fourth grade mathematics, specifically. The library of interactive content datasets may be navigated using navigation tools provided by the client application 302, which are further described with reference to at least FIGS. 7A-7C, and the content management engine 204 may cooperate with the navigation tools by providing requested information and suggesting related interactive content complementary to what is being viewed by one or more users 122.

In some embodiments, the content management engine 204 may receive a content request for a particular interactive content dataset (e.g., an interactive book) and, in response thereto, may retrieve and send the dataset. In some embodiments, the content request is received via the network 110 from the client application 302 executing on a client device 118, and the content management engine 204 queries the data store 228 for the interactive content dataset specified in the content request and transmits the interactive content dataset to the client device 118 for display. For example, responsive to receive a content request for an interactive electronic book on how to interact with students having autism, the content management engine 204 retrieves the dataset describing the electronic book from the data store 228 and transmits the dataset to the client application 302 for display to the user 122 requesting the book.

In some embodiments, the content management engine 204 may receive authoring signals for creating, modifying, and supplementing an interactive content dataset, and the authoring instructions may include data defining the new content or data describing the portions of the previously created interactive content stored in the data store 228 that should be deleted or modified. The authoring signals may also identify how the data should be deleted or modified, which user authorized the deletion or modification, etc. For example, to create a new interactive electronic book or revise an existing interactive electronic book, the content management engine 204 may receive authoring instructions defining the author, metadata, text, bookmarks, and rich media, such as text, video, audio, surveys, polls, attachments, etc., and the content management engine 204 creates and formats the dataset representing the electronic book and stores it in the data store 228. The functionality provided by the content management engine 204 is advantageous in a number of ways including providing an authoring user 122 the ability to up-date his/her interactive content, for example an electronic book, real-time. These updates may represent iterations to an electronic book, a subsequent version of the electronic book and/or may represent updates made in response to feedback provided by readers using the interactive functionality provided at least in part by the interactivity module 206. Additionally, updates to interactive content may be made real-time and thus represent the most recent information, trends, findings, etc., pertaining to one or more topics.

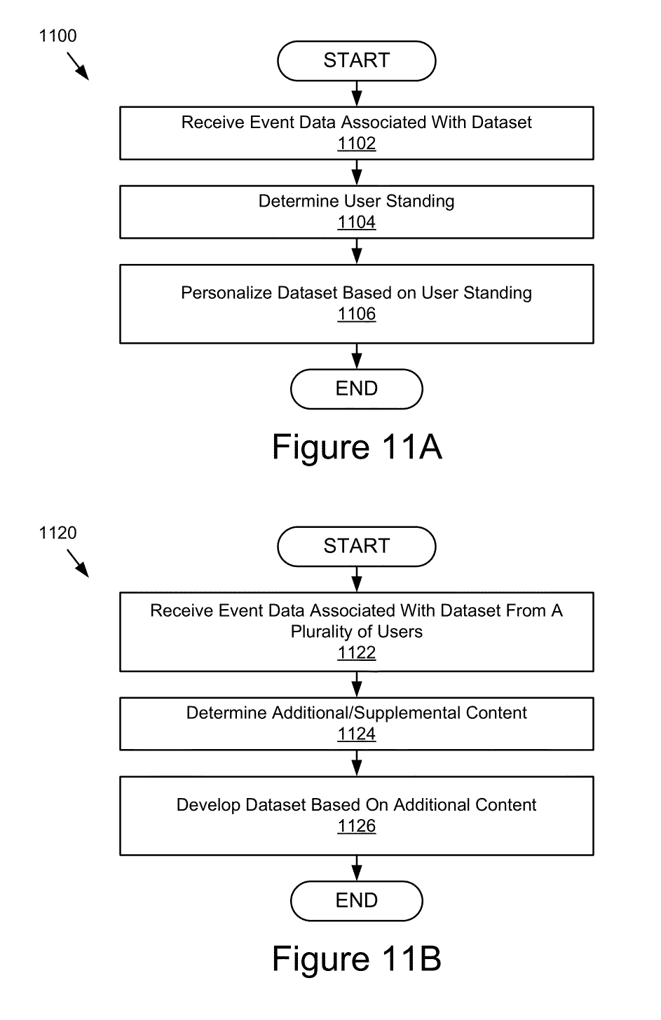

In some embodiments, the content management engine 204 may automatically personalize/develop the content of an interactive content dataset. For example, the content management engine 204 may determine a user standing of a user requesting and/or interacting with an instance of an interactive content dataset, and may automatically adjust the substance/difficulty/complexity of the dataset's content (e.g., such as the subject matter covered by the text, media, documents, presentations, surveys, tasks, assignments) based on the user's standing. The content management engine 204 may also build-out/develop the content of a given dataset based on the user interaction with the dataset. For example, if a group of users are collaborating on/discussing a particular section of a dataset using the interactive features of the dataset (e.g., comments, bookmarks, forum discussions, wall, etc.), the content management can automatically identify supplemental electronic resources to complement that section with based on one or more of these interactions, the users connections to one another, the content of that section of the dataset, the users collective standing, etc. In some embodiments, the content management engine 204 cooperates with the interactivity module 206 to receive and process the event data. In other embodiments, the content management engine 204 receives the event data independently. Additional examples of automatic personalization/development of dataset content are discussed in further detail below with reference to at least FIGS. 11A-B.

In some embodiments, the content management engine 204 may generate and send user interface information to the client application 302, instructing the application, at least in part, on how to format and display interactive content to the user. For example, the client application 302 may generate one or more user interfaces including interactive content based at least in part on the interface information. In other embodiments, the interface instructions on how to format and display the interactive content to the user are generated by the client application 302, or by another locally or remotely operated application that specifies that the content be formatted and displayed according to an organization's specific needs and/or standards.

The interactivity module 206 is software, code, logic, or routines for managing user interaction with interactive content. In some embodiments, the interactivity module 206 is a set of instructions executable by the processor 222 to provide this functionality. In other embodiments, the interactivity module 206 is stored in the memory 224 of the server 102 and is accessible and executable by the processor 222 to provide this functionality. In any of these embodiments, the interactivity module 206 may be adapted for cooperation and communication with the processor 222 and other components of the server 102 via the bus 220.

In some embodiments, the interactivity module 206 provides functionality for interacting with interactive content provided by the content management engine 204. For example, the interactivity module 206 provides functionality for bookmarking locations within the interactive content; viewing bookmarks input by users 122 including a user 122 who authored the content; commenting on the interactive content or portions thereof; viewing comments input by users 122, and commenting on those comments; attaching data files such as video, audio, image and document files, etc.; viewing attached video, audio, image and document files, etc., and embedded video, audio and images; viewing embedded or attached slide shows; viewing embedded polls or surveys; viewing a bird-eye navigational view of the interactive content; creating forum threads for discussing the interactive content or portions thereof; viewing the discussion threads; sharing links to the interactive content or portions thereof via email, within the professional development or educational service operated by the application engine, in a journal entry, or on one or more social network services operated by one or more a third-party servers 114; etc. In some embodiments, an interaction by a user with an interactive content dataset reflects a learning, training, professional development activity, etc. being performed by that user. In some embodiments, the interactivity module 206 cooperates with the client application 302 via the network 110 to provide this functionality. For example, the client application 302 may generate a user interface, such as the user interfaces depicted in FIGS. 7A-10B, for displaying dialogs for interacting with the interactive content as described above, and when various commands are input by a user 122 via the dialogs, the client application 302 signals the interactivity module 206 via the network 110 to store and/or provide information related to the commands.

In some embodiments, the interactivity module 206 tracks user interaction with the interactive content provided by the content management engine 204 by storing event data describing all user interaction with the interactive content in the data store 228. In some embodiments, the sequence and level of interaction with the interactive data is also described by the event data stored in the data store 228. For example, the event data may describe whether audio or video embedded in the interactive content was played to completion; muted during playback, fast-forwarded, etc.; whether comments made by a user 122 are substantive, how long it took for a user to navigate the interactive content; whether all of the interactive content was navigated; whether a user 122 wrote a journal entry about the interactive content; whether a user 122 discussed or shared the interactive content with other users 122; the tasks completed by a user; etc. In some embodiments, the interactivity module 206 cooperates with the content management engine 204 to personalize and/or develop the content of an interactive content dataset. For example, the interactivity module 206 may receive event data describing interactions with an interactive content dataset, or section or feature thereof, by one or more users, and may signal the content management engine 204 to change or modify the existing content of the dataset, or supplement the existing content with electronic resources, provided, for example, by via the application engine 104. In other embodiments, the content management engine 204 may perform this functionality.

The ranking module 208 is software, code, logic, or routines for ranking user interaction with interactive content. In some embodiments, the ranking module 208 is a set of instructions executable by the processor 222 to provide this functionality. In other embodiments, the ranking module 208 is stored in the memory 224 of the server 102 and is accessible and executable by the processor 222 to provide this functionality. In any of these embodiments, the ranking module 208 may be adapted for cooperation and communication with the processor 222 and other components of the server 102 via the bus 220.

In some embodiments the ranking module 208 cooperates with the interactivity module 206 to surface the most pertinent and/or relevant interactions with interactive content datasets managed by the content management engine 204. For example, a popular electronic book may include certain paragraphs that are frequently commented on. To filter out the less relevant or helpful comments, the ranking module 208 may analyze information associated with the comments to determine how much weight should be attributed to the comments. In some embodiments, comments by an author/user 122 are ranked higher and given more weight than comments by readers/users 122. By way of further illustration, the ranking module 208 may analyze attribute information associated with the comments may include view count, indication by other users that they approve/dis-approved of or liked/dis-liked the comments, metadata, reply count, user affinity, etc., and/or may analyze the substance of the comments to determine influence/weight. In some embodiments, the weightier comments may be associated with a higher ranking than less weighty comments.

The ranking module 208 is advantageous because it allows important, influential, relevant, helpful etc., comments to be surfaced and shown to a user 122. For example, the ranking module 208 provides a convenient mechanism for users 122 to navigate an interactive content dataset having numerous user interactions with popular paragraphs, such as comments, shares, forum threads, attachments, etc., by filtering the comments and surfacing and showing comments which may be relevant, important, influential, helpful, etc. For example, the ranking module 208 may surface comments made by users 122 included in the viewing user's 122 social graph to provide a meaningful social experience. In another example, a user 122 whose user profile suggests that he/she (e.g., a teacher) needs to improve in facilitating discussion in the classroom, the ranking module 208 may surface and show comments related to that topic to provide additional helpful reading and resources for that user 122.

The data store 228 is an information source for storing and providing access to organized collections of data. In some embodiments, the data store 228 is included in the memory 224 of the server 102. In other embodiments, the data store 228 is included in a server or storage system distinct from but accessible by the server 102. In various embodiments, the data store 228 stores records, files, objects, etc., in cooperation with a file system executable by a processor. The data store 228 may additionally or alternatively include a database management system (DBMS) executable by a processor to manage a collection of records, files, objects, etc. For example, the database could be a structured query language (SQL) DBMS. In these embodiments, the server 102 includes or is coupled to this database via a bus or a network to store data in multi-dimensional tables having rows and columns, and manipulate, i.e., insert, query, update and/or delete, rows of data using programmatic operations (e.g., SQL queries and statements).

In some embodiments, the interactive content engine 202 may include an aggregator (not shown) for aggregating various types of data from various information sources, including the third-party server 114 and client devices 118. In some embodiments, this data can be used by the content management engine 204 to personalize, modify, supplement, and/or develop the interactive content datasets. In some embodiments, the aggregator can aggregate the data at various intervals (every few minutes, hours, days, weeks, etc.) and store it in the data store 228.

### Example Client Device 118

FIG. 3 is a block diagram illustrating a client device 118 according to some embodiments of the present disclosure. In the depicted embodiment, the client device 118 includes the client application 302, a communication unit 306, a processor 308, a memory 310, a graphics adapter 314, and an input device 318. The client device 118 also includes a display 316, which is coupled to the graphics adapter 314. The components 306, 308, 310, 314, 316 and 318 are communicatively coupled via the bus 312. The bus 312 may any type of communication bus configured to connect the components of the client device 118 for exchanging data. The bus 312 may include one or more of a variety of bus architectures including a memory bus, memory controller, a peripheral bus, a local bus, etc. Additional structure and functionality of the client device 118 is discussed herein with reference to at least FIG. 1.

The processor 308 comprises an arithmetic logic unit, a microprocessor, a general purpose controller, or some other processor array to perform computations and optionally provide electronic display signals to the display device 316. The processor 308 communicates with the other components via the bus 312. The processor 308 processes data signals and may comprise various computing architectures including a complex instruction set computer (CISC) architecture, a reduced instruction set computer (RISC) architecture, or an architecture implementing a combination of instruction sets. Although only a single processor 308 is shown in FIG. 3, multiple processors may be included. The client device 118 may also include an operating system executable by the processor 308.

The memory 310 stores instructions and/or data that may be executed by memory 310. The memory 310 communicates with the other components of the client device 118 via bus 312. The instructions and/or data comprise code for performing any and/or all of the techniques described herein. The memory 310 may be a dynamic random access memory (DRAM) device, a static random access memory (SRAM) device, flash memory, or some other known memory device. In some embodiments, the memory 310 also includes a non-volatile memory or similar permanent storage device and media including, for example, a hard disk drive, a floppy disk drive, a CD ROM device, a DVD ROM device, a DVD RAM device, a DVD RW device, a flash memory device or some other mass storage device known for storing information on a more permanent basis.

The communication unit 306 includes wired and/or wireless interfaces for interacting with other devices/networks of devices. In some embodiments, the communication unit 306 includes transceivers for sending and receiving wireless signals. For example, the communication unit 306 includes radio transceivers (4G, 3G, 2G, etc.) for communication with the mobile network 106, and/or radio transceivers for WiFi™ connectivity. The communication unit 306 may also include transmission devices configured for Bluetooth® connectivity, near field communication (NFC), etc. In the depicted embodiment, the communication unit 306 is coupled to the network 110 via signal line 116 for communication and interaction with the other entities coupled to the network 110. In these or other embodiments, the communication unit 306 may include a network interface device (I/F), which includes ports for wired connectivity. For example, the communication unit 306 includes a CAT-5 interface, USB interface, or SD interface, etc.

The graphics adapter 314 displays images and other information on the display 316. The graphics adapter 314 may be a separate processing device including a separate processor and memory (not shown) or may be integrated with the processor 308 and/or memory 310. The display 316 represents any device equipped to display electronic images and data as described herein. The display 316 may be any a conventional display device, monitor or screen, such as an organic light-emitting diode (OLED) display, a liquid crystal display (LCD). In some embodiments, the display 316 is a touch-screen display capable of receiving input from one or more fingers of a user 122. For example, the display 316 may be a capacitive touch-screen display capable of detecting and interpreting multiple points of contact with the display surface.

The input device 318 is any device for inputting data on the client device 118. In some embodiments, the input device 318 is a touch-screen display capable of receiving input from the one or more fingers of the user 122. The functionality of the input device 318 and the display 316 may be integrated, and a user 122 of the client device 118 may interact with the client device 118 by contacting a surface of the display 316 using one or more fingers. For example, the user 122 interacts with an emulated (i.e., virtual or soft) keyboard displayed on the touch-screen display 316 by using fingers to contacting the display in the keyboard regions. In other embodiments, the input device 318 is a separate peripheral device or combination of devices. For example, the input device 318 includes a keyboard (e.g., a QWERTY keyboard) and a pointing device (e.g., a mouse or touchpad). The input device 318 may also include a microphone, a web camera, or other similar audio or video capture devices.

### Example Client Application 302

With reference to FIG. 3, the client device 118 contains the client application 302. The client application 302 is software, code, logic, or routines for presenting information, receiving user input, sending and receiving information. In some embodiments, the client application 302 cooperates with the application engine 104, the interactive content engine 106, and/or the third-party server 114 via the network 110 to provide the functionality described herein. While the client application 302 is described herein as including various structure and functionality, it should be understood that, in other embodiments, the structure and functionality could be performed, at least in part, by the application engine 104 and/or the interactive content engine 106, and vice versa, and that these other embodiments are contemplated and within the scope of the present disclosure.

In some embodiments, the client application 302 is a set of instructions executable by the processor 308 to provide its functionality. In other embodiments, the client application 302 is stored in the memory 310 of the client device 118 and is accessible and executable by the processor 308 to provide the functionality. In any of these embodiments, the client application 302 may be adapted for cooperation and communication with the processor 308 and the other components 302, 306, 310, 314, 316 and 318 of the client device 118. In some embodiments, the client application 302 is client code operable as a web browser, a customized client-side application, or a combination of both. For example, the client application 302 may be client code downloadable from an application marketplace operated by a third-party server 114, such as an application storefront (“appstore”), and operable as a client-side application that includes the features described herein.

The client application 302 may generate user interfaces for displaying, viewing, navigating, and editing, etc., information received from the application engine 104 and/or the interactive content engine 106, receiving input signals from a user 122; generate data and instructions based on the input signals; and send the data and instructions to the server 102 or third-party server 114. In some embodiments, the client application 302 generates user interfaces, such as those depicted in FIGS. 7A-10B, based at least in part on information received from the interactive content engine 106, the application engine 104, and/or the third-party server 114 via the network 110. For example, the client application 302 may receive, at least in part, interface instructions from the server 102 or third-party server 114 via the network 110 in the form of a mark-up language (e.g., HTML, XML, etc.), style sheets (e.g., CSS, XSL, etc.), graphics, and/or scripts (e.g., JavaScript, ActionScript, etc.), and the client application 302 may interpret the interface instructions and render an interactive Web User Interface (WUI) for display on a client device 118 based thereon.

In some embodiments, the client application 302 may render a graphical user interface that displays corresponding cross-linked interactive content datasets simultaneously. For example, as a chapter or portion of a first interactive content dataset may directly relate to a chapter or portion of second interactive content dataset, the client application 302 may display the datasets side-by-side to provide a convenient two-column reading experience to the user. For example, this two column interface may allow a user to read about a subject in the scholarly reference in one column while completing certain tasks pertaining to that subject by interacting with the practical reference in another column.

In some embodiments, the client application 302 is coupled to the input device 318 via the bus 312 to receive input signals from the user 122. For example, a user 122 composes a comment using the input device 318, and the client application 302 receives signals describing the composed comment and stores the signals in the memory 310 for use or later retrieval by the client application 302. In some embodiments, the user interfaces generated by the client application 302 include user interface elements that allow the users 122 to interact with the client devices 118 and input information and commands, such as text entry fields, selection boxes, drop-down menus, buttons, virtual keyboards and numeric pads, etc. For example, a comment entry form may include an input field, such as a drop-down menu, for optionally inputting the users 122 to which the comment is directed and a text field for defining the body of the comment. In selecting users, the user 122 can, for example, select from users 122 to which the user 122 is connected with via some common trait. The client application 302 may generate this drop-down menu by instructing the application engine 104 via the network 110 to provide a list of users 122 to which the user 122 is connected in the social graph, and upon receiving the list, populating the drop-down menu with the users 122 described by it. Examples of user interfaces generated by the client application 302 can include, but are not limited to, the user interfaces depicted in FIGS. 7A-10B, which are further discussed below.

### Example Methods

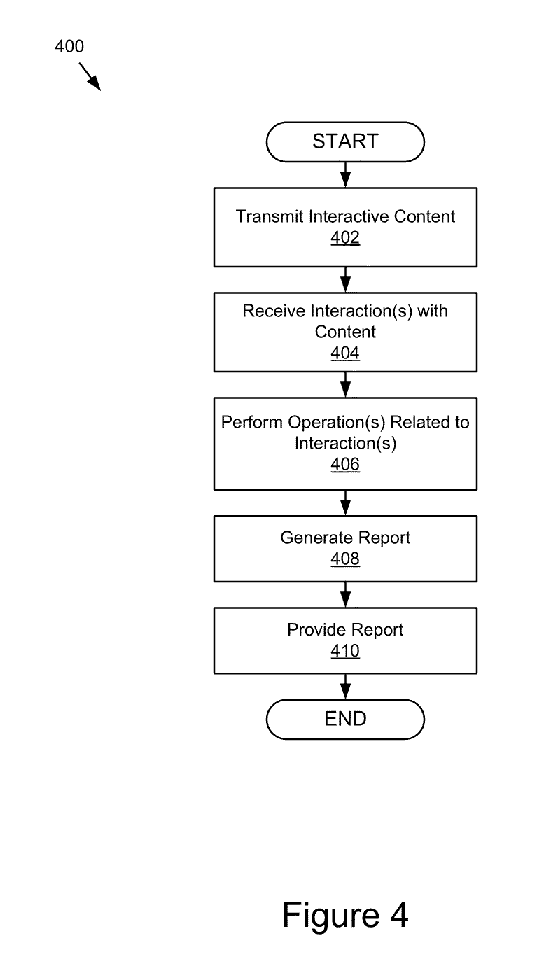

Referring now to FIGS. 4-6 and 11A-B, various embodiments of the methods of the present disclosure are described. FIG. 4 is a flowchart of an example method 400 for providing and managing user interaction with interactive content. The method 400 begins by the content management engine 204 transmitting 402 an interactive content dataset to a client device 118 via the network 110 for display to a user 122 of the client device 118. In some embodiments, the interactive content dataset is transmitted to the client device 118 responsive to receiving a request for the dataset. For example, the user 122 may select a pointer (e.g., a hyperlink) to the dataset provided by a navigation interface rendered by the client application 302 and, responsive thereto, the content management engine 204 may send the interactive content dataset via the network 110 to the client application 302 for display to the user 122.

The method 400 continues by the interactivity module 206 receiving 404 event data describing one or more user interactions with/revisions to the interactive content dataset from a client device 118, and the interactivity module 206 performs 406 operations corresponding to the interactions. In various embodiments, the interactivity module 206 annotates or modifies local instance/master copy of the dataset with the interactions/revisions. In these or other embodiments, the interactivity module 206 can perform an operation by recording, in the data store 228, user behavior associated with the interactive content (e.g., event data describing paging of the dataset, which interface elements were interacted with, how long a user utilized a given dataset, whether audio or video embedded in the interactive content dataset was played to completion; muted during playback, fast-forwarded, etc., whether any content was downloaded (e.g., audio, video, file attachments, etc.), which tasks/activities were completed; annotating a local copy of the dataset stored in the data store 228 with input/content provided by the user (e.g., bookmarks, comments, poll/survey results, user shares, likes, dislikes, forum threads/discussions, work-product, outlines, documents, photos, videos, audio, tasks/activities completed, etc.); creating or supplementing a forum thread in association with the application engine 104; sharing the content by generating and sending an electronic message (e.g., an email, instant message, text message, internal message, etc.); sharing the content in cooperation with a social networking service operated by the application engine 104 or a software application hosted by the third-party server 114; creating and storing a journal entry for the user 122 about the interactive content dataset in the data store 228; revising the local copy of the dataset stored in the data store 228 to add, modify or remove text, an image, a video file, an audio file, a document attachment, a poll, a survey, a bookmark, an outline, etc.; etc.

In a further example, a user 122 interacting with the interactive content dataset may bookmark a passage of the interactive content dataset for later viewing, make a comment, complete an assigned task, or use any other interactive functionality described herein, and the interactivity module 206, upon receiving the event data, stores event data associating the interaction with a user profile of the user in the data store 228 so when the user 122 returns at a later time to view the interactive content dataset, the event data associating the interaction with the user may be retrieved and presented to the user by the client application 302. In another example, if a user 122 shares a passage of the interactive content dataset with other users 122 in that user's 122 social graph or using social networks operated by third-parties, upon receiving event data describing the share, the interactive module 206 associates the share with the passage and a user account of the user, and then may proceed to execute a sharing routine to share the passage or a pointer to the passage (e.g., a hyperlink) with the intended recipients.

The method 400 continues by the reporting module 202 generating 408 a report describing user interaction with the interactive content dataset and providing the report to one or more recipients. In some embodiments, the report is generated 408 based at least in part on the reporting module 202 receiving a report instruction. The report instruction may be automatically generated by the interactive content engine 106, the application engine 104, or another source, or the instruction may be generated and sent by the client application 302 via the network 110. For example, a user 122 may provide input instructing a report be generated 408 by the reporting module 202 using a user interface provided by the client application 302, and the client application 302 may generate the report instruction and transmit it to the reporting module 202 for execution. The method 400 then provides 410 the report to one or more designated recipients. The recipients and/or the mechanism for providing 410 the report may be defined by the report instruction or may be predefined and stored as data in the data store 228. In some embodiment the report is provided to one or more designated recipients by email. In other embodiments, the recipient is the user 122 who requested the report and the report is transmitted to the client application 302 for display to the user or for saving by the user. The method 400 is then complete and ends.

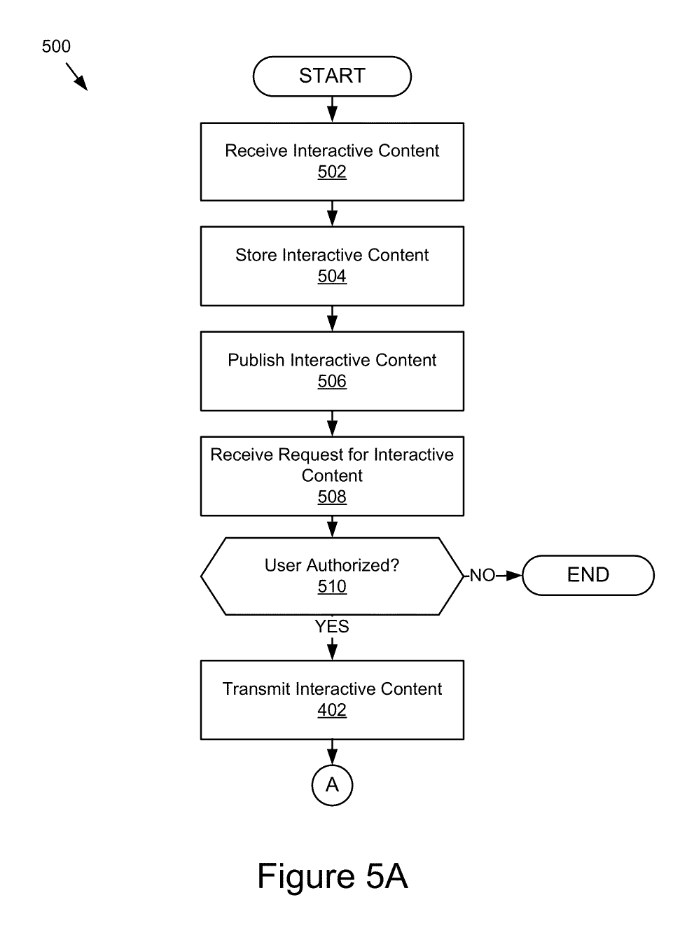

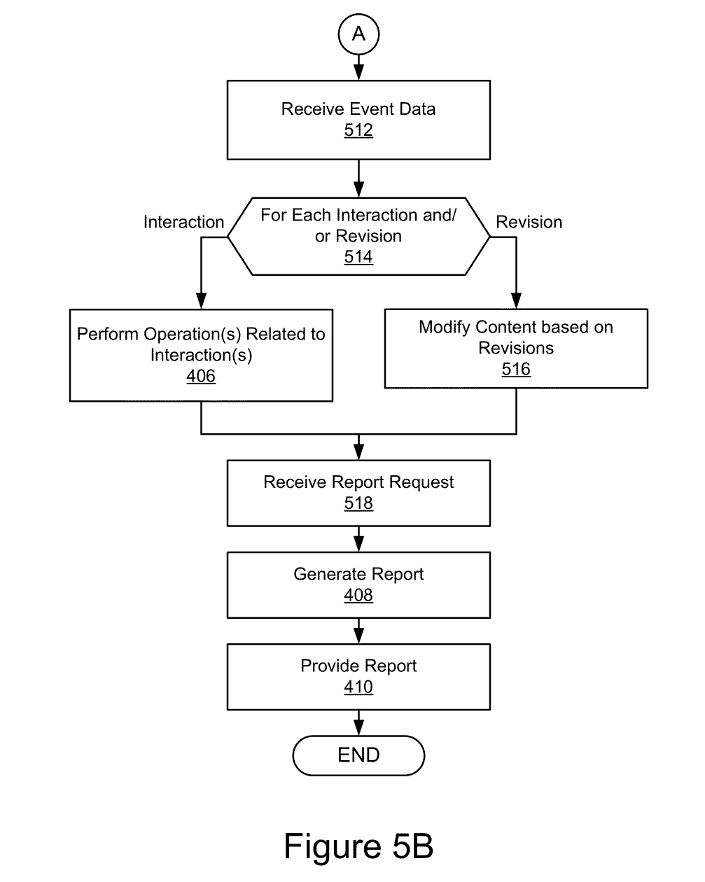

FIGS. 5A and 5B are flowcharts of another example method 500 for providing and managing user interaction with interactive content. As depicted in FIG. 5, some of the blocks of the method 500 are the same or similar to the blocks of the method 400. For convenience and ease of understanding, those blocks have the same reference numerals and perform the same or similar functions, and their description will not be repeated in full here.

The method 500 begins by the content management engine 204 receiving 502 an interactive content dataset and storing 504 the interactive content dataset in the data store 228. In some embodiments, the interactive content dataset may be provided server-side by an administrator user 122 of the interactive content engine 106. In other embodiments, the interactive content dataset may be authored by an authorized user 122 using the authoring functionality provided by the client application 302 in cooperation with the content management engine 204. In some embodiments, the content management engine 204 is configured to cooperate with the client application 302 to provide an editing workflow which allows for an iterative process in which a user 122 authoring the content can submit it over the network 110 via a user interface to another user 122 for editing, and once edited, it can be submitted over the network 110 back to the user 122 authoring the content via a user interface, and so on and so forth until interactive content dataset is approved by the author and/or editor.

The method 500 continues by the content management engine 204 publishing 506 the interactive content dataset. In some embodiments, the content management engine 204 may publish 506 the interactive content dataset by storing data in the data store 228 indicating that the interactive content dataset is available for viewing. In this way, the interactive content dataset may be included in the library by the application engine 104 and presented by an interface of the client application 302. For example, the client application 302 can present a user interface element for navigating and selecting the datasets of the interactive content library managed by the application engine 104. Next, the method 500 receives 508 a request for the interactive content dataset from a client device 118 of a user 122. For example, a user may select an icon or hyperlink representing the interactive content dataset using an interface generated by the client application 302, and the client application 302 may generate and send a request for the interactive content dataset to the content management engine 204 via the network 110. In another example, the request may be received in response to a user selecting, using the client application 302, an embedded link included in a previously transmitted scholarly electronic book that references a specific portion of a corresponding electronic workbook.

Upon receiving 508 the request for the interactive content dataset, the interactive content engine 106 may determine 510 whether a user 122 requesting the interactive content dataset is authorized to do so. In some embodiments, the interactive content dataset may require a license to be viewed. In other embodiments, the interactive content dataset may be freely available for viewing by all users. Some interactive content datasets may be offered as a sample of a larger interactive content dataset. For example, an electronic book containing the first two chapters may be freely available to all users 122, while the full electronic book containing all of the chapters (e.g., more than two) may require users 122 to have a license to view it. In some embodiments, to determine 510 whether the user 122 requesting the interactive content dataset is authorized, the interactive content engine 106 may query the data store 228 for the user profile of the user 122 authenticated with/logged in to the client application 302 and for data describing that the user profile has a license to view the interactive content dataset being requested. If the user 122 is determined 510 by the content management engine 204 not to be authorized, the user 122 is informed that the user 122 does not have access and the method 500 is then complete and ends.

In some embodiments, even if a user 122 is licensed to view the interactive content dataset, the user 122 may be restricted from sharing or reproducing all or portions of it. For example, the user 122 may be prevented from using a copy/paste functionality of the client application 302, or may be limited to copying and pasting a certain amount of content. In some embodiments, the copy/paste functionality may be enabled, either fully or in a limited fashion, provided the user account of the user has been provided authorization and/or licensed to use the copy/paste functionality. This is advantageous as it prevents the users 122 from widely distributing or sharing the content with other users and thereby potentially violating copyright protections afforded to the author of the content. Additionally, among other benefits, it may provide the author/user 122 assurance that his or her content will not be copied/pirated. In other embodiments, the copy/paste functionality may be fully enabled providing the users 122 and the author/user 122 alike the ability to share/distribute content from the dataset, or incorporate the content from the dataset into their own works, such as lesson plans, articles, etc.

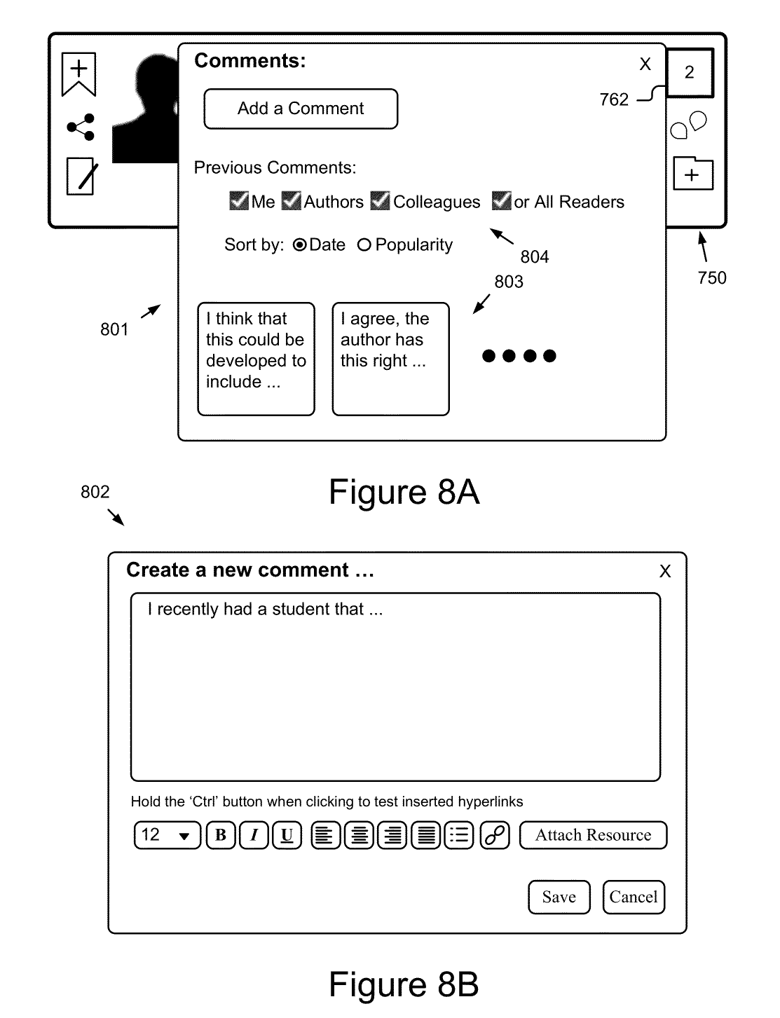

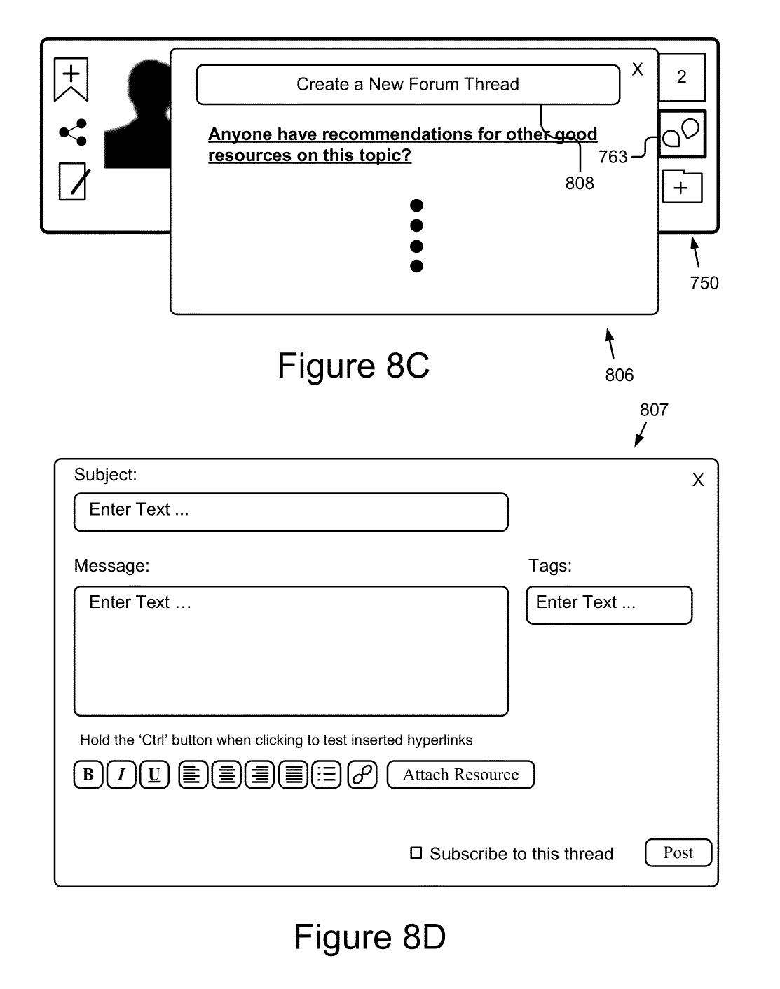

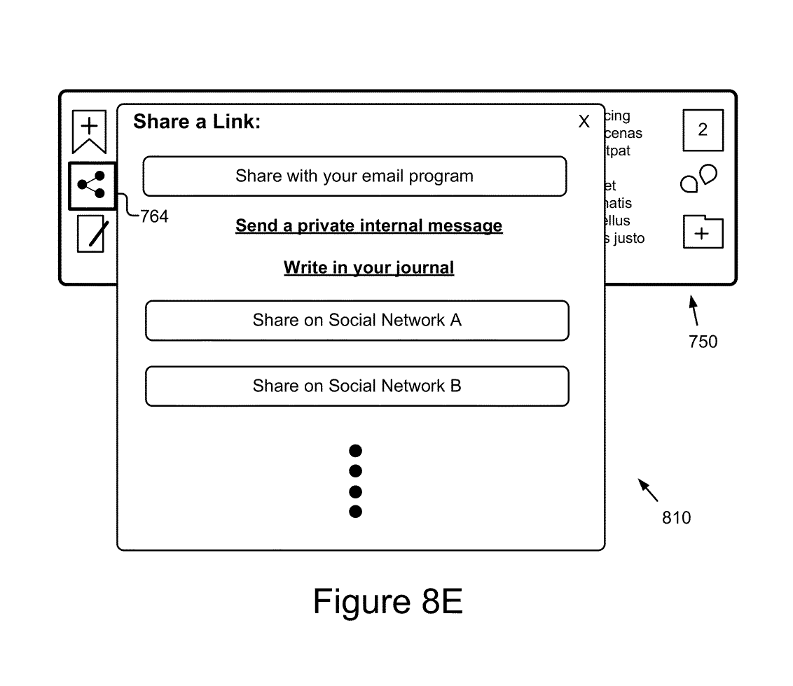

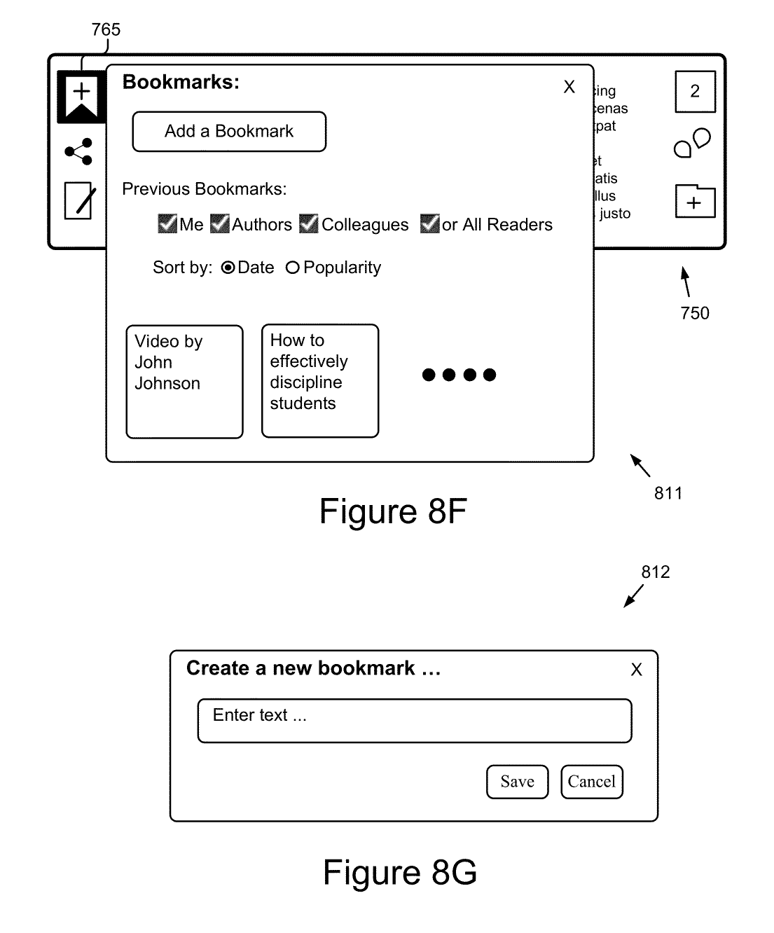

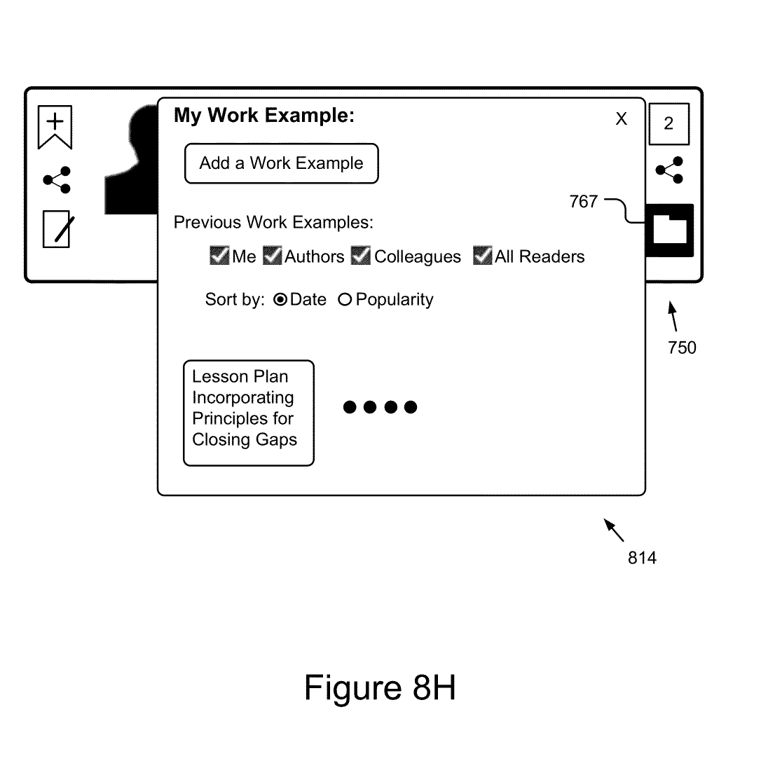

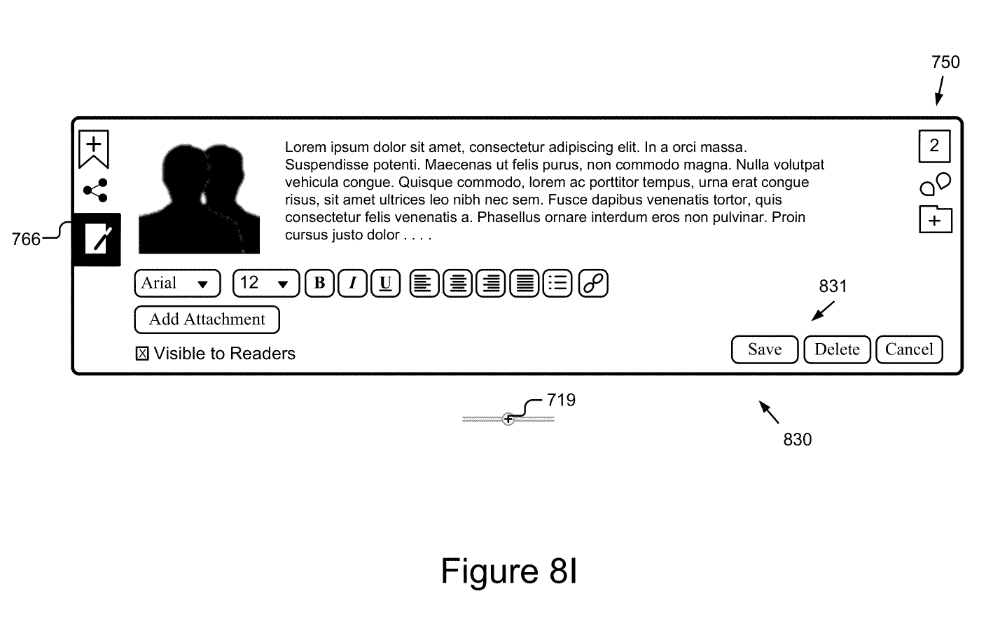

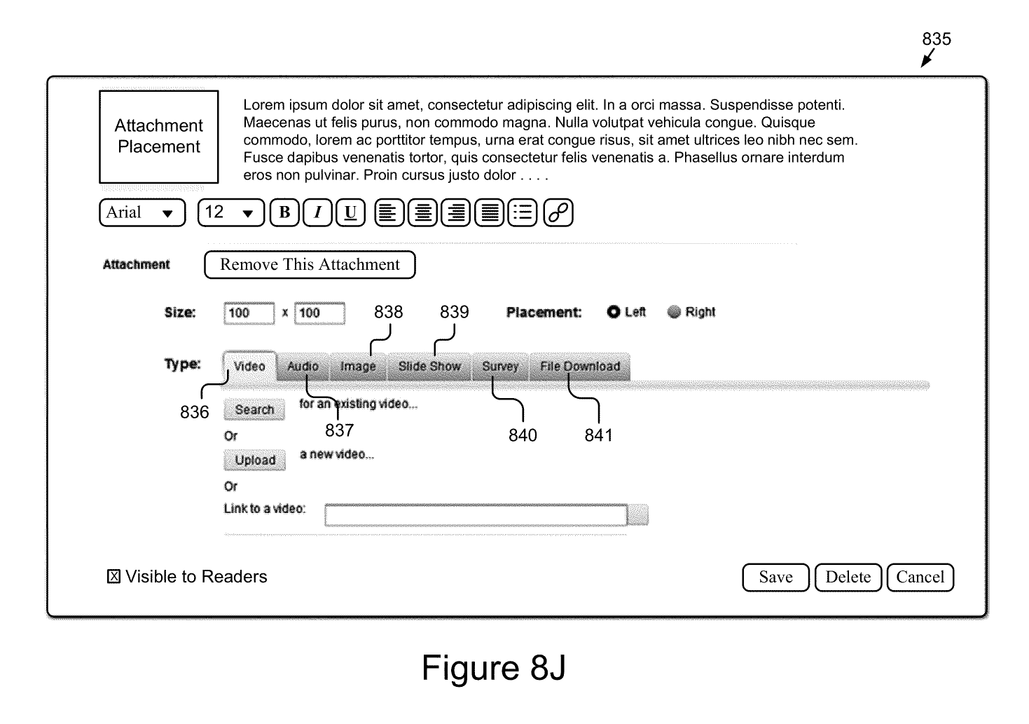

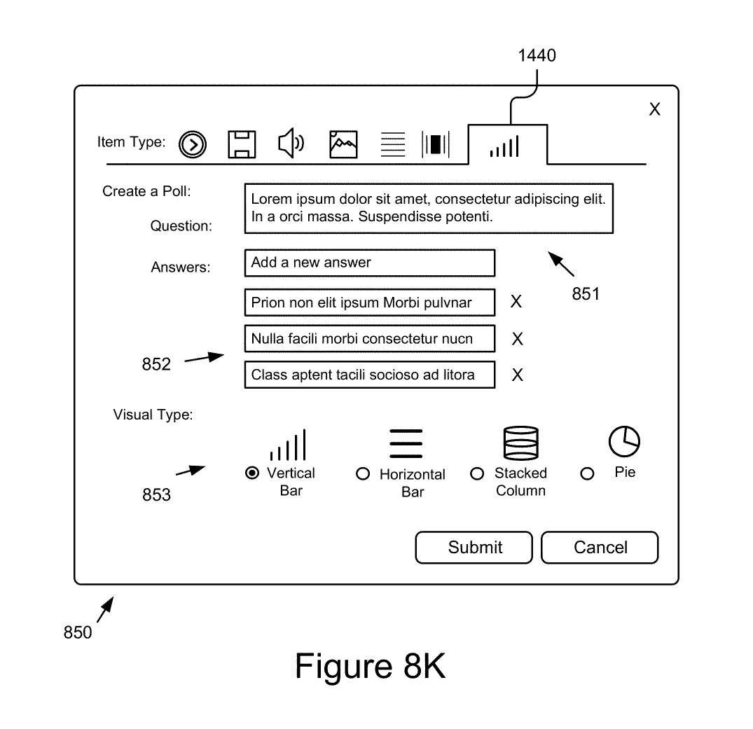

If the user 122 is determined 510 by the content management engine 204 to be authorized, the content management engine 204 transmits 402 the interactive content dataset to the client device 118 of the user 122 for display, as previously described. In some embodiments, the client device 118 to which the interactive content dataset is transmitted is being operated by the user 122 who authored it or a user 122 who is authorized to edit it, and the client application 302 generates a user interface for displaying the interactive content dataset that includes editing tools for editing the interactive content dataset (e.g., see FIGS. 8I-8K) along with tools for interacting with the interactive content dataset (e.g., see FIGS. 7A-8H and 9A-10B). In various other embodiments, the interactive content dataset is transmitted to a client device 118 that is operated by a user 122 who is only authorized to view and interact with the interactive content dataset, and the client application 302 generates a user interface for displaying the interactive content dataset that includes the tools for interacting with the interactive content dataset (e.g., FIGS. 7A-8I and 9A-10B).

The method 500 continues by the content management engine 204 and/or the interactivity module 206 receiving 512 event data from the client device 118 of the user 122 viewing the interactive content dataset. The event data may include revision(s) to the interactive content dataset and/or interaction(s) with the interactive content dataset. For each interaction, the method 500 processes 514 it as previously discussed above with reference to block 406. For each revision, the method 500 processes 514 it by modifying 516 the interactive content dataset based at least in part on revision information included in the event data. In some embodiments, a local instance of the interactive content dataset serves as a master copy and any instances of the dataset that are transmitted to client devices 118 in block 402 are derived from this master copy. In these embodiments, the local instance/master copy of the dataset is annotated or modified with any interactions or revisions received in block 512, and then any instances being displayed by the client devices 118 are updated to reflect the interactions and/or revisions. For example, the content management engine 204 may receive a revision instructing the content management engine 204 to modify a paragraph, add a paragraph or additional content to a paragraph (such as embedding video, audio, etc.), etc., and the content management engine 204 modifies 516 the local instance of the interactive content dataset accordingly.

The content management engine 204 may provide versioning functionality for the interactive content by tracking revisions to the interactive content dataset and allowing the revisions to be reversed. For example, the content management engine 204 may store an instance of each interactive content dataset, or store an original instance of the interactive content dataset and instances of each subsequent revision and the order in which they were made so that one or more of the revisions may be reversed at a later time. The content management engine 204 may allow provisional revisions to be made without affecting the published version of the interactive content dataset. For example, a user 122 authoring the interactive content dataset via the client application 302 may provisionally add a section to the interactive content dataset by selecting a checkbox designating the additions as not being visible to users 122 viewing the content (e.g., see FIG. 8I). Upon saving the additions, the client application 302 may send the revision including the provisional additions to the content management engine 204, and the content management engine 204 may update the interactive content dataset to include the additions and designate those additions as provisional using metadata.

The method 500 continues by the reporting module 202 receiving 518 a report request. The report request may be a report instruction generated and provided by any of the entities of system 100 to the reporting module 202, or may be self-generated by the reporting module 202. The report instruction may define the scope, content, and/or recipients of the report to be generated or may simply be an instruction to generate the report. Upon receiving 518 the report instruction, the reporting module 202 may generate 408 and provide 410 the report as previously described above with reference to blocks 408 and 410. In some embodiments, the report is generated 408 and provided 410 responsive to receiving the report instruction. In other embodiments, the report is autonomously generated 408 and provided 410 (e.g., at regular intervals) based on predefined parameters describing its scope, content and/or recipients. The method 500 is then complete and ends.

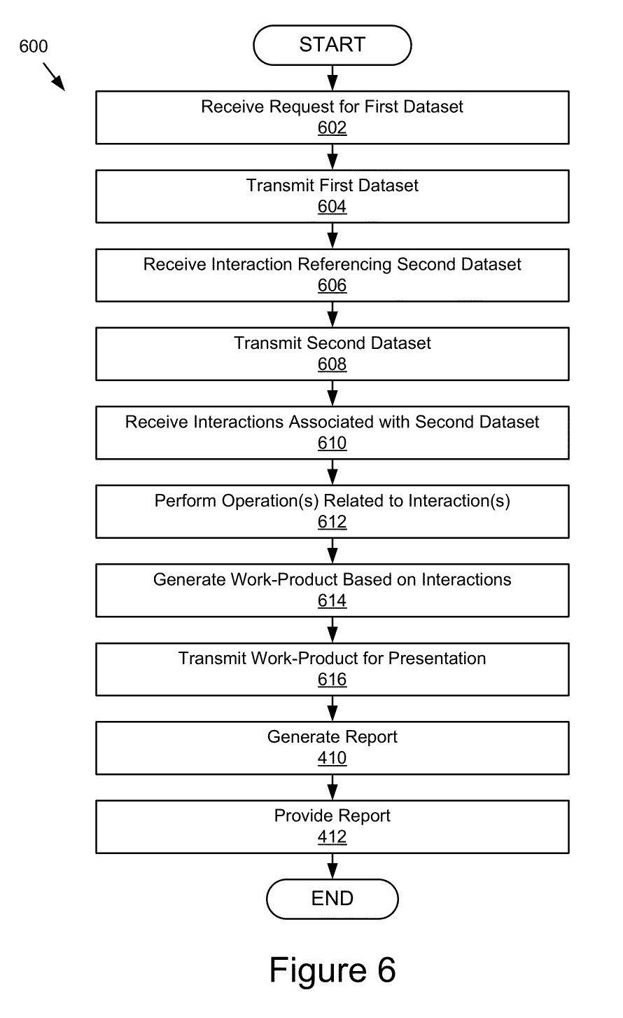

FIG. 6 is a flowchart of an example method 600 for providing and managing user interaction with corresponding interactive content datasets. As depicted in FIG. 6, some of the blocks of the method 600 are the same or similar to the blocks of the method 400. For convenience and ease of understanding, those blocks have the same reference numerals and perform the same or similar functions, and their description will not be repeated in full here. Further, it should be understood that various operations included in each of the processes 400, 500, and 600 are interchangeable, and in some cases, are compatible variations of other operations described herein. Furthermore, the methods described herein should not be considered as limiting and other methods/processes based on the combination or expansion of various aspects of these processes 400, 500, and 600 are contemplated and within the scope of the present disclosure.

The method 600 begins by receiving 602 a request for a first interactive content dataset from a client device 118, and in response, retrieves and transmits 604 the first interactive content dataset to the client device 118. In some embodiments, the interactive content engine 106 manages the receipt of the request and the transmittal of the dataset. Next, the method 600 receives 606 event data reflecting an interaction with the first interactive content dataset that references a second interactive content dataset. For example, the interaction may reflect the selection by a user of an electronic resource reference (e.g., a uniform resource identifier (URI)) referencing a second interactive content dataset or portion/section/aspect thereof. In a further example, the event data may be an HTTP GET request for the second interactive content dataset or a portion thereof.

The method 600 continues by transmitting 608 the second interactive content dataset to the client device 118 and then receiving 610 event data describing one or more interactions with the second dataset from the client device 118. The method 600 then performs 612 operation(s) associated with the interaction(s). Various examples of operations that can be performed are discussed elsewhere herein. Further examples include flagging predefined tasks associated with the second interactive content dataset as complete; annotating the interactive content dataset with the input (e.g., comments, etc.) provided by the user 122 in response to questions posed by the dataset; etc.

Next, the method 600 generates 614 a work-product, such as a lesson plan, a presentation, a paper, a book report, a completed form, a certificate, test/quiz results, an implementation plan, etc., based on the user's 122 interaction(s) with the second interactive content dataset and/or the first interactive content dataset. In some embodiments, to generate the work-product, the interactivity module 206 retrieves information reflecting the user 122's interaction(s) with the interactive content dataset and populates a template with that information. For example, the template may be a lesson plan and the user input/event data used to populate the template may be answers to questions posed by the dataset about a particular lesson.

The method 600 then transmits 616 the work-product for presentation. In some embodiments, the interactivity module 206 transmits the work-product to the user 122 who submitted the request for the first dataset in block 602. In other embodiments, the interactivity module 206 transmits the work product to an administrator or educator of the user 122. In some embodiments, the work-product may be transmitted via a network protocol in the form of an e-mail message, an attachment to an e-mail message, a webpage, an electronic document, etc. Next, the method 600 generates 410 and provides 412 a report as discussed above with reference to at least FIG. 4. In some embodiments, the report may include, among other information, the work-product generated in step 614, information about the first and second interactive content datasets, information about how the user interacted with those datasets, a performance assessment on the user's interactions with one or more of the datasets, etc. The method 600 is then complete and ends.

With reference to FIGS. 11A-B, example methods for automatically personalizing, adapting, developing, etc., the content of an interactive content dataset are described. In particular, FIG. 11A depicts an example method for personalizing an interactive content dataset based on user standing. The method 1100 begins by receiving 1102 event data associated with an interactive content dataset. In some embodiments, the event data may be a request for an instance of a particular interactive content dataset. In other embodiments, the event data may reflect an interaction by a user with an aspect of an interactive content dataset. By way of example, the event data may reflect the completion of a task/assignment associated with interactive content dataset, the consumption of various embedded content (e.g., viewing video, listening to audio, highlighting a section of the interactive content dataset with the interactivity toolbar, enlargement and viewing of an graphical image, etc.), the submission of a comment, the setting of a bookmark, or any other interaction as described elsewhere herein.

The method 1100 continues by determining 1104 the standing of the user that is interacting with the interactive content dataset. The user's standing may reflect how the user is performing with reference to a standard or requirement, how the user is performing in comparison with other users at his/her level, how a user is performing in a particular setting, task, job, class, subject, etc. By way of illustration, the content management engine 204, in cooperation with the reporting module 202, may determine a user's standing by analyzing achievement data associated with the user, observation data assessing the performance, effectiveness, compliance of a user relative to various requirements and/or standards, achievement data associated with the user's students, and/or other performance data associated with the user's areas of responsibility, etc. In a further example, the user's standing may be based on one or more of the assessment(s), test score(s), grade(s), progress or lack thereof, or the like, of the user. This data may be stored in and retrievable from the data store 228. For instance, if the user is a student and is interacting with a textbook for a particular class the student is taking, the method 1100 may determine the user's standing based on that student's grade(s), test score(s), assignment score(s), etc., generally or in that particular class, as reflected by the achievement data stored in the data store 228. In some embodiments, the user's standing may be a real-time snapshot of the user's progress/performance/compliance, etc. In other embodiments, the user's standing may be a historical-snapshot that accounts for any progress or erosion thereof over time.

Next, the method 1100 personalizes the interactive content dataset based on the user's standing. In some embodiments, the complexity of the subject matter taught by the interactive content dataset is automatically increased or reduced proportional to the user standing determined in block 1104. Additionally or alternatively, the interactive content dataset can be supplemented with additional content for meeting the specific needs of the user. In these or other embodiments, the author of the interactive content dataset and/or the instructor of the user can be electronically notified of the user's standing by the reporting module 202 and an instance of the interactive content dataset for that user can be personalized based on the input provided by the author and/or instructor.

By way of illustration, when authoring an interactive content dataset, the author may create content for users at varying difficulty levels and the content management engine 204 may personalize the instance of the dataset designated for the user by automatically adjusting the difficulty level of its content based on the user standing computed in block 1104. In another example, the content management engine 204 may personalize an instance of the interactive content dataset provided to that user by identifying additional/supplemental content specifically targeted to address the needs of that user, as reflected by the user's standing. For example, the content management engine 204 may personalize the instance of the interactive content dataset being provided to the user with highly relevant tasks, activities, training videos, educational podcasts, content from/links to other interactive content datasets, forum discussions, etc., that addresses any specific issues, needs, weaknesses, deficiencies, or the like of the user. In yet other embodiments, the content management engine 204 may use the user's social graph to identify the electronic resources that helped to improve the standing of other users that are connected to the user, and may suggest those resources, facilitate a dialog between those users (e.g., via a forum discussion, electronic messaging, or by creating a learning community which includes those users), etc. In further examples, the content management engine 204 may access the social graph of the user to identify and assign a suitable mentor to the user who has experience mentoring other users with the same or similar needs. The method 1100 is then complete and ends.

FIG. 11B depicts an example method for adapting an interactive content dataset based on event data received from a plurality of users. The method 1120 begins by receiving 1122 event data associated with an interactive content dataset from a plurality of users, determines 1124 additional content with which to develop (e.g., supplement, modify, etc.) the interactive content dataset based on the event data, and then uses this additional content to develop 1126 the interactive content dataset. For example, several users may comment on, share, bookmark, complete a task for, download supplemental content about, etc., a particular portion of an interactive content dataset that describes a particular topic, subject, or theory, and the method 1120 may use the interaction data describing these interactions to further develop or customize that portion of the interactive content dataset.

In some embodiments, the method 1120 may use one or more of the metadata associated with the dataset or a portion thereof, words and phrases included in the interactive content dataset, and/or words or phrases from the comments, bookmarks, and/or shares, to query for one or more additional/supplemental electronic resources provided by the application engine 104 and/or the interactive content engine 106. For instance, the content management engine 204 may use keywords from a highlighted portion of the interactive content dataset being interacted with by the users (e.g., via the interactivity toolbar 750) to identify other interactive content datasets, videos, documents, presentations, web-links, forum discussions, groups, etc., and transmit data describing these resources to the client devices 118 of these users for display in association with the highlighted portion of the interactive content headset being interacted with by these users. In another example, the content management engine 204 may query the social graphs of the users to identify other related electronic resources (e.g., related e-books, videos, podcasts, documents, presentations, forums, websites, etc.) that users have interacted with, and serve up those resources in association with the dataset or section thereof being interacted with by the users. In further examples, the content management engine 204 may invite the users (e.g., via an associated interface or dialog) to participate in an associated forum discussion thread, or form a group in the social graph including those users and provide social networking functionality for those users to continue to interact. The method 1120 is then complete and ends.

It should be understood that the methods 1100 and 1120, as well as methods 400-600, are provided by way of example and that expansions to, variations of, and/or combinations of these methods, or aspects thereof, are contemplated and within the scope of this disclosure. For example, in some embodiments, the user's standing in block 1102 may be pre-computed, i.e., computed prior to block 1104. In this or other examples, the personalization of the dataset may be based on criteria other than the user's standing. For example, the dataset may be personalized based on the other users that the user is connected to in the social graph; preferences, likes, and/or dislikes of the user; the content that the user has consumed previously (i.e., other datasets, video, audio, documents, surveys completed, bookmarks set, comments made, any other electronic resource interactions, etc.); or the like. These methods 1100 and 1120 provide numerous advantages including providing self-guided, personalized instruction in a dynamic and socially interactive environment.

### Example User Interfaces

FIGS. 7A-10B are graphic representations of embodiments of user interfaces for authoring, viewing, and interacting with interactive content according to some embodiments of the present disclosure. In particular, FIGS. 7A-D are graphic representations that describe various aspects of a user interface 700 for selecting, viewing, editing and interacting with interactive content datasets provided by the content management engine 204 according to some embodiments. The user interface 700 may be displayed by the client application 302 and may be accessed, utilized or employed by one or more users 122. The user interfaces generated and presented by the client application 302 may include a variety of metadata or other status indicators, completion or progress bars, navigation tools, other tools and tool icons, tool bars, dialogs, radio or option buttons, checkboxes, and the like configured to permit the user 122 to interact with one or more chosen interactive content datasets or to facilitate reciprocal communication regarding a specified dataset between the user 122, multiple users, and/or the client application 302. In such embodiments, the various metadata indicators, tools, toolbars, dialogs, radio or option buttons, checkboxes and the like are viewable, accessible, and/or otherwise usable via the user interface 700.

For example, various embodiments of the user interfaces generated by the client application 302 may include authoring tools for authors to divide an interactive content dataset into chapters and/or sections, add pop-up coaching tips (including text, video, audio and/or other content types discussed herein) for readers in various portions of the dataset, rename tabs for displaying interactive content datasets and associated content, format the text of the dataset (e.g., wrap the text), select between pop-up attachments or embedded attachments, color code different elements of the dataset, disable multiple-column reading/require single-column reading, create/enable/display/provide an information box for all attachments associated with a dataset, select which authors are viewable to a reader, etc.

The user interfaces generated by the client application 302 may also include pop up dialogs for attachments, options for a user 122 to toggle between 1, 2, or more columns, a dialog for displaying a table of contents, slideshow controls for displaying various dataset content, a single-selection purchase option for purchasing one or more datasets (e.g., a set of corresponding/cross-linked datasets), highlighting functionality, a slider tool for navigating/selecting pages of an interactive content dataset, a thumbnails preview for the slider tool to depict various pages/content of a dataset, corner page click zones for turning pages, animation of page turning, functionality to move and/or combine menus (e.g., to move a sidebar menu to a top grey toolbar as a set of icons), provide glowing icons or dynamic effects when hovered over, navigation tools like auto scrolling to various locations based on user selection (e.g., selecting a catalog element auto scrolls a window to a catalog section, clicking on a dataset in the catalog auto scrolls the window to a viewer section, etc.), functionality for users 122 to upload and share their files, such as lesson plans, presentations, resources, other work-product, etc., with other users that interact with a given dataset, etc.

In various embodiments, the user interface 700 is fully customizable such that a user can organize the user interface 700, and the associated assortment of tools, such that the efficacy and convenience of using the user interface 700 is maximized per an individual viewer's preferences. In other embodiments, the user interface 700 is partially customizable while in yet other embodiments the user interface 700 is not customizable at all such that its appearance is uniform and easily recognizable and usable by users 122 already familiar therewith.

To open a dataset, in some embodiments, the user 122 can select from among the various titles included in the dataset library 778 (also referred to herein as a catalog), which represent various different interactive electronic books. Access to one or more interactive content datasets may, in some embodiments, be restricted and the datasets may be encrypted such that a user 122 must enter a password or comply with other security protocols to access a given dataset. In other embodiments, the library 778 may only show dataset titles 705 to which the user 122 has previously been given access. In still other embodiments, the user 122 is provided with both a library 778 of available dataset titles as well as suggested or recommended dataset titles to which the user 122 may already have access or be licensed to view or to which the user 122 may gain access or be licensed to view.

In some embodiments, a user 122 may be provided with a catalog/library 778 of one or more dataset choices and/or recommendations 705. In some embodiments, the catalog 778 is accompanied by a scrollable navigation region 702 which permits a user 122 to view or navigate multiple dataset titles in the catalog 778. The navigation region 702 may include a visual representation reflecting the user's 122 position and/or progress relative to a select group of datasets. In some embodiments, multiple catalogs 778 accompanied by multiple slidable navigation regions 702 are provided. In such embodiments, the multiple catalogs relate to or are otherwise separated relative to subject, category, genre, author, contributors, date, length, or other indices. In other embodiments, the user may view the catalog 778 in a full screen layout. In such embodiments, the contents of catalog 778 may still be organized by various helpful indices. In various embodiments, an icon or other image, such as the cover of a book or the artwork on a musical album, may be used to visually represent or symbolize separate datasets to facilitate the ease and convenience of selecting between the datasets.

Once the user 122 has selected an interactive content dataset of his or her choosing to which he or she has access, the dataset may be displayed in the window 701 by the client application 302. In some embodiments, the user 122 gains access to a chosen title/interactive content dataset via the network 110 (e.g., the Internet) and can view and/or interact with the dataset and/or other users 122 in real-time via the network 110. In other embodiments, the user may download the dataset to local storage and interact with it offline via the client application 302, and once the user returns online, the client application 302 can synchronize the user's interactions and interactions of others in cooperation with the server 102. When viewing the dataset, the window 701 may be resized as desired such that the user can observe the dataset in a variety of views and sizes including full page, dual page, print layout, web layout, outline and so forth. In addition, in such embodiments, the window 701 may be minimized or sized as desired and the user may zoom in or out as desired. In various embodiments, the user is permitted to open one or more instances of the client application 302 such that one or more user interfaces 700 and/or windows 701, or portions thereof, are open and accessible simultaneously (e.g., two corresponding, cross-linked datasets).

Upon selection of a dataset, information that is germane to the dataset may be displayed, such as an image 780 associated with the dataset, the title 703 of the dataset, the identity of the original author or authors 704 of the dataset, the identity of subsequent contributing authors or editors of the dataset (not shown), the publisher of the dataset (not shown), the volume number or edition number associated with any publication(s) of the dataset (not shown), a description of the dataset, a list of publications in which the dataset has been published previously (not shown) and so forth. Some embodiments provide the user 122 with additional metadata 707 related to the real-time use of or access to the interactive content dataset, such as the number of readers, discussion posts, contemporaneous authors or contributors (not shown) and/or other users who are viewing, editing, reviewing, or otherwise using instances of the dataset at any given moment. In some embodiments, the additional metadata 707 is continuously maintained and updated in real-time by the client application 302 in cooperation with the application engine 104.

The user interface 700 may include various tools for interacting with a given interactive content dataset and/or other users 122, such as a search box 760, a checkbox 761 for e-mailing the user 122 updates to a given interactive content dataset, a main toolbar 706, an interactivity toolbar 750, and a navigation toolbar 756. In some embodiments, the various tools may be combined into the same toolbar or toolbars. In other embodiments, they may be distinct and separate from one another. For example, the navigation toolbar 756 may be integrated with the main toolbar 706 or may be a stand-alone element located, for example, along a periphery of the window 701.

The search box 760 may, in some embodiments, include a text field for receiving search terms and/or keywords from the user 122. The search box 760 may provide the user the ability to search the interactive content dataset being displayed, annotations describing user interaction with the interactive content dataset, and other content included in the library 778 managed by the interactive content engine 106. For example, upon entering search terms into the search box 760 and selecting enter, the client application 302 generates and sends a search request to the content management engine 204, and the content management engine 204 queries available interactive content datasets for content matching the search terms and provides search results summarizing the query to the client application 302 for display to the user 122. In this or other examples, the client application 302 may search the instance of the interactive content dataset being displayed for information, such as relevant passages and user interaction, matching the search terms provided.

The check box 761 allows a user 122 to receive notification of updates to the interactive content datasets. By way of example, when the check box 761 is selected, the client application 302 may send a signal to the interactive content engine 106 via the network 110 instructing the content management engine 204 to provide notification of updates to the interactive content dataset to the user 122, and the content management engine 204 may store record of the instruction and notify the user 122 of any updates for a given period of time or until subsequent instruction is provided to cease the provision of updates to the user 122. In these or other embodiments, the notification of updates or the updates themselves may be provided to the user 122 via electronic messaging, such as e-mail, instant message, an internal messaging system, etc.

In the depicted embodiment, the main toolbar 706 includes tabs 708, 709, 711, and 712, a version dropdown menu 790, an editing mode toggle button 768, a navigation element 717, a text size adjustment element (not labeled), and a view expansion element 782. While four tabs (708, 709, 711, and 712) are depicted as included in the main toolbar 706, any number of tabs could be included and could provide different views and/or functionality to the user 122. In some embodiments, the user 122 can customize and add or remove tabs as desired. In addition, it is contemplated that the tabs can be organized and/or oriented in any manner and subsequently reorganized and/or reoriented as desired. For example, the tab 709 could be located to the far left of the user interface 700 while the tab 708 could be located at the far right of the user interface 700. In these or other embodiments, the various tabs could be located on the left hand side, the right hand side, the top, and/or the bottom of the user interface 700 so as to maximize the efficacy of using such tabs. Accordingly, the user may be permitted to relocate any single tab or group of tabs as desired in order to customize the user interface 700. Likewise, the content of each tab may be altered as desired.

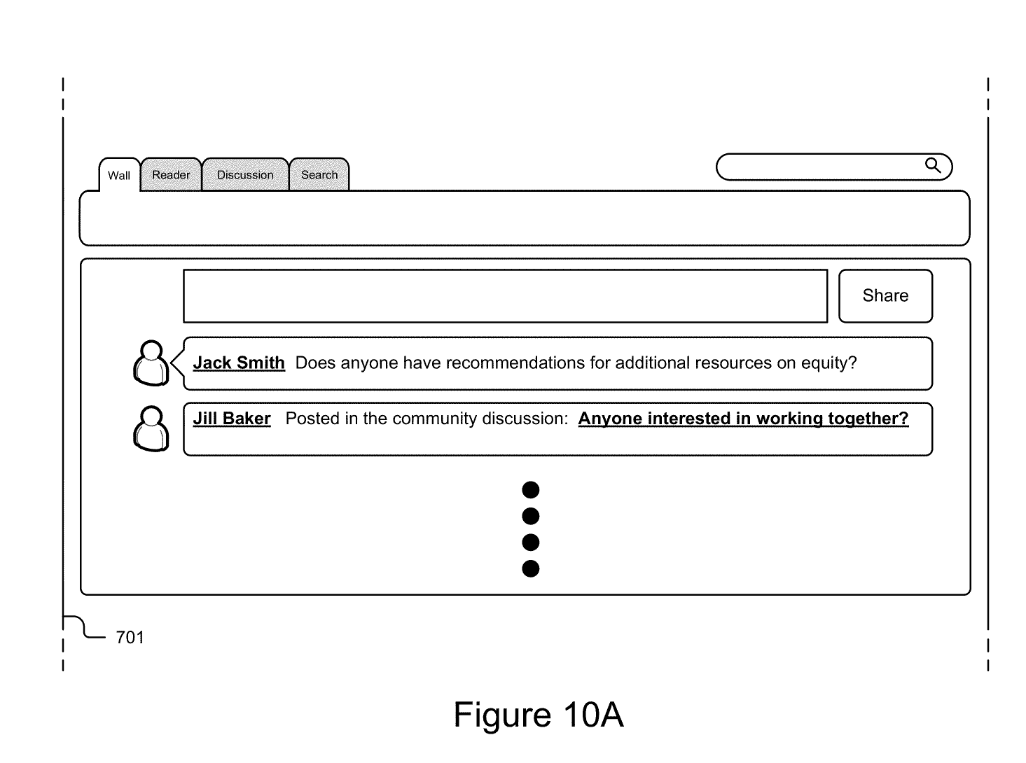

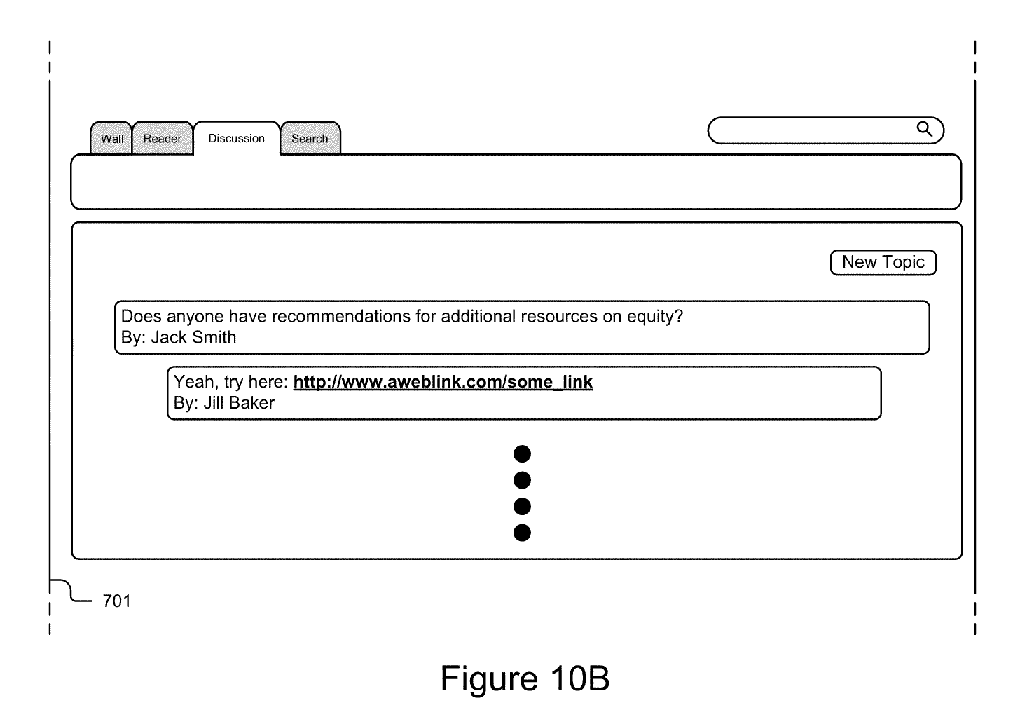

The “wall” located at the tab 708 (e.g., see FIG. 10A) represents a live stream of activity associated with the interactive content dataset, and may include an aggregation of changes made to the interactive content dataset, author announcements, additions/annotations including comments, links to resources, documents, white papers, lesson plans, improvement plans, presentations, community discussions, etc. The “wall” conveniently provides a user 122 with the ability to view all user interactions with the interactive content dataset in one location as they occur. The “wall” also provides users 122 and the author/user 122 alike the ability to conduct discussions about the interactive content dataset, etc., in a casual forum, which can serve as a broadcast mechanism to other users 122 using the functionality of the interactive content engine 106 or the application engine 104.

The tab 709 can display the body 770 of a given interactive content dataset. In some embodiments, the body 770 of the interactive content dataset may include textual information, visual aids, such as a pictures, graphics, images, photographs, graphs, charts, polls, surveys, diagrams, tables, grids, figures, drawings, illustrations, maps, embedded audio, embedded video, links to portable files containing any of the foregoing, and the like. In some embodiments, the body 770 may be segmented into sections which can be activated to display the interactivity toolbar 750 by user selection or interaction (e.g., hovering). By way of example, an embedded video player window 721 can be enlarged to permit an enhanced viewing experience of an associated video file or an embedded image 723 can be enlarged by user selection to permit a more detailed examination of the image.

The tab 711 may provide the user 122 with an interface depicting discussion threads related to a particular interactive content dataset (e.g., see FIG. 10B) and may permit the user 122 to discuss the dataset with other users, authors, contributors and the like. Various options for discussing a given dataset and/or viewing ongoing or prior discussions regarding a given dataset are discussed in greater detail below. Selecting the tab 712 may display a user interface (not shown) for searching the information related to the interactive content dataset. For example, the user 122 could search the dataset for certain keywords or phrases, search for user interaction with the interactive content dataset, such as comments, discussion threads, etc., search for other resources provided by the interactive content engine 106 or the application engine 104, etc.

The version dropdown menu 790, when activated may display metadata related to a given interactive content dataset, such as information about the most current version of the dataset, recent changes to the dataset, the author of the most recent change(s) to the dataset and so forth. In various embodiments, the metadata included in the dropdown menu 790 may be expanded or contracted to show more or less metadata and the metadata itself can be organized and displayed according to the user 122's preference in both its expanded and contracted states. FIG. 7D depicts an example of a dialog 791 that is displayed when the dropdown menu 790 is selected by a user 122. This dialog 761 may include, among other things, more detailed metadata about the history and development of the dataset, such as a list of contributing authors and/or readers as well as a history of changes, including, but not limited to, deletions, additions and the like, the dates on which such changes were made and/or a brief description of any such change(s).

Some embodiments of the dialog 791 may include tools, such as checkboxes, which permit a user to identify a list of tasks that need to be completed in association with a given interactive content dataset and a brief description of any such tasks. In such embodiments, the description associated with checkbox(es) is updated as a given task is completed and the checkbox is selected. For example, an author or user can make a checkbox noting that a certain portion of a dataset needs to be reviewed and/or edited or otherwise suggesting that a certain portion of a given dataset be reviewed and/or edited. In a further example, when the checkbox is unselected, the brief description might say that the text on a given page of a document needs to be edited. Once the edits have been made and checkbox is selected, the brief description can be changed to read that edits on a given page of a document have been made. In this way, one or more authors, readers or other contributors can track modifications to a given dataset in real-time. Likewise, assignments regarding a given dataset can be made and tracked in real-time.

The dialog 791 may also include links 744 which permit the user to jump to a specific location in the dataset, such as the location of edits that have been made or assignments that have been completed. The links 744 may be customizable. For example, in some embodiments, the links 744 themselves may be created, added, deleted, removed, or otherwise configured by an author, a reader, or other contributors. The links 744 may also be customized to provide some brief information about the contents of the dataset, such as what was added or deleted and the like. In other embodiments, default links 744 and terminology employed within associated descriptions may be generated by the content management engine 204 and/or the client application 302 as the dataset evolves over time. The foregoing features can be used by readers and authors alike to facilitate the usefulness and/or evolution of a given dataset over time.

In the depicted embodiment, navigation element 717 permits a user 122 to selectively advance or otherwise move forward through the contents of an interactive content dataset, such as a book or musical composition file. In other embodiments, navigation element 717 permits a user 122 to selectively recede or otherwise move backward through the contents of an interactive content dataset, such as a book or musical composition file. Specifically, by way of example and not limitation, a user 122 is permitted to move forward and/or backward through the pages or chapters of an interactive content dataset, such as a book, via navigation element 717. The navigation element 717 may also permit a user to move directly to other sections of a dataset, such as the index or glossary of an interactive book and the like. In these or other embodiments, a user can also select the exact location in a given dataset (such as a chapter or page of a book) he or she wishes to view via a drop down menu, as discussed further with reference to navigation toolbar 756. In this way, a user can move to a specific point (section, chapter, page, etc.) in the chosen dataset without having to view intervening sections, chapters, pages or the like.

In some embodiments, the navigation element 717 is located in a header, footer or both to enhance the ease and convenience of navigating the contents of a chosen dataset. In other embodiments, navigation links are provided in sidebars and/or other dock-able tool bars (not shown). It is further contemplated that, for the purpose of editing a given dataset, such as adding and/or removing text, images, audio files, and so forth, the sections, chapters, page numbers or other divisions within a given dataset are not fixed but variable such that they can be added to or otherwise increased and/or subtracted from or otherwise decreased. The user-selectable view expansion icon 782 can provide functionality for expanding the viewing field of the user interface 700.

The interactivity toolbar 750 provides functionality for a user 122 to annotate a selected section of the interactive content dataset with bookmarks, comments and forum discussions, share portions of the interactive content dataset with other users 122, and edit portions of the interactive content dataset. For example, as depicted in FIG. 78, the interactivity toolbar 750 includes a comment button 762, a forum button 763, a share button 764, a bookmark button 765, an edit button 766, and an attachment button 767. In some embodiments, the interactivity toolbar 750 selects/highlights various sections of the interactivity content dataset based on the input provided by the user. For example, if a user selects, hovers over, interacts with scrolls by, etc., a section of the interactive content, the client application 302 can reposition the interactivity toolbar 750 to highlight that section. This allows to the user to annotate specific sections of the dataset using the functionality of the toolbar 750. In other embodiments, the user can specify which sections that his or her interactions/annotations should be associated with. In yet other embodiments, the interactions/annotations may be associated automatically with various sections of the dataset or the entire dataset by the client application 302.

FIGS. 8A-K are graphic representations that describe example user interface elements associated with the elements 762, 763, 764, 765, 766, and 767 of the interactivity toolbar 750. For example, the comment button 762, when selected, may initialize a comment dialog 801 as shown in FIG. 8A for adding new comments, viewing comments by the user 122 and other users 122 (e.g., the author, colleagues, etc.), and selecting previously added comments for revision or deletion. In some embodiments, the comment button 762 itself can reflect the number of comments that have been made about the highlighted section of the dataset (e.g., the number “2” reflects that two comments have been made about the highlighted section). When a user selects the button labeled “Add a Comment,” a comment addition dialog 802 may be displayed as shown in FIG. 8B. The comments added via the comment addition dialog 802 can be associated with the section of the interactive content dataset highlighted by the interactivity toolbar 750. In some embodiments, the comment addition dialog 802 includes options for formatting the comment being input, embedding hyperlinks, and attaching files, such as the file and content types described herein with reference to the content attachment dialog 785.

The comment dialog 801 may include filtering elements 804 to filter comments 803 pertaining to a particular section of the interactive content dataset. For example, comments 803 can be filtered using various checkboxes and/or radio buttons. In some embodiments, the comments 803 can be filtered according to, among other things, author, date, popularity, subject matter, colleagues, groups, attachments, and so forth. Further, the comments 803 can be categorized such that they can be seen and responded to by a chosen population according to a user 122's preference. For example, a user might use the filters to search for past comments or for those most popular. In some embodiments, the comments 803 may be previously sorted and filtered by the ranking module 208 prior to being sent to the client application 302 for display, and can optionally be further filtered using the options described above. The filtering options described with reference to the content dialog and the ranking and sorting performed by the ranking module 208 may also be applicable to and included in the functionality of the other dialogs associated with the interactivity toolbar 750, such as the bookmarking dialog, the forum dialog, etc.

The forum button 763, when selected, may initialize a forum dialog 806 as shown in FIG. 8C for creating a new forum thread for viewing existing forum threads that relate to the section of the interactive content dataset highlighted by the interactivity toolbar 750. The forum dialog 806 may display a button 808 for creating a new forum thread as well as links for viewing existing threads that pertain to the content of the dataset highlighted by the interactivity toolbar 750. In some embodiments, selecting the button for creating a new forum thread/discussion initializes a thread creation dialog 807 for defining the thread, including options for defining tags for the thread, entering text to define the title and initial content of a thread, as well as text formatting and file attachment options as discussed elsewhere herein. In other embodiments, selecting to create or view forum thread will automatically switch the tab being displayed by user interface 700 to the discussions tab 711 as depicted in FIG. 10B. Once the thread is added, unique metadata, such as hidden tags, may be used to match the thread with the section being discussed, which allows all threads created for a particular section of the interactive content dataset to be aggregated by the interactivity module 206 and provided to the client application 302 for display in a single interface element, such as the forum dialog. In various embodiments, selecting a link to view an existing thread in the dialog 806 may switch the tab being displayed to the discussions tab 711 to display the associated thread/discussion (e.g., see FIG. 10B), may open a new window or dialog to display the associated thread/discussion, or may display a hidden region in the dialog 806 to show the associated thread/discussion.

The share button 764, when selected, may initialize a share dialog 810 as depicted in FIG. 8E for sharing information from the highlighted section of the interactive content dataset with other users 122. In some embodiments a hyperlink or URL referencing the section of the interactive content dataset being shared may be sent to other users 122 via e-mail, an internal messaging system, a journal entry, or a third-party social networking service operated on a third-party server 114, etc. In other embodiments, the entire contents of the section of the dataset being shared may be included in a message to another user 122 or users 122, a journal entry, shared as an update on a social network, etc.

The bookmark button 765, when selected, may initialize a bookmarking dialog 811 as shown in FIG. 8F for creating bookmarks referencing the highlighted section of the interactive content dataset and displaying previously created bookmarks for that section by the user 122 and/or other users 122, such as author/user 122. For example, a user 122 may select the button labeled “Add a Bookmark” and a bookmark definition dialog 812 may be displayed, as shown in FIG. 8G, for entering a description of the bookmark. In some embodiments, the bookmarking dialog 811 may include filter options, such as the filter options previously described with reference to the comment dialog, to filter out bookmarks of other users, such as an author/user 122. By way of example, bookmarks may be added by an author/user 122 to designate the location of additional supplemental content, such as a sample lesson plan attached to the section bookmarked by the author/user 122. In some embodiments, the bookmarking dialog may include sharing functionality when creating a bookmark allowing users 122 to select other users 122, for example, from their social graph, to share the bookmark with when creating it. This sharing functionality is also applicable to the other the dialogs associated with the interactivity toolbar 756 that are described herein.

The attachment button 767, when selected, may initialize a dialog 814 for displaying work examples (e.g., documents, presentations, lesson plans, etc., created by the user) uploaded for attachment to the dataset by the user and other users 122. In some embodiments, selection of the “Add a Work Example” may initialize a file attachment dialog, such as a dialog allowing a user to select a file stored on the client device 188 of the user 122.

Some embodiments of the user interface 700 includes authoring tools for adding content to or editing the content of a given interactive content dataset. For example, with reference to FIG. 7A, the main toolbar 706 may include an editing mode toggle button 768 for toggling the editing functionality on and off. For example, when the editing mode is toggled on, the content editing icons 719 and 766 may be unhidden and made available for user selection. In some embodiments, the user 122 accessing the user interface 700 must be authorized to activate the editing mode. The content editing icon 719, when selected, may open a content composition dialog 830 (e.g., see FIG. 8I) for adding a new section to the interactive content dataset in the location where the selected content editing icon 719 is located. The content editing icon 766, when selected, may open a content composition dialog 830 (e.g., see FIG. 8I) that has been populated with the content from the section highlighted by the interactivity toolbar 750. As depicted in FIG. 7A, the content editing icon 766 may be displayed for selection by the client application 302 when a section of interactive content dataset is hovered over with a pointing device over and/or selected by a user 122.

Once opened, the content composition dialog 830 may remain open as a separate window or be selectively closed between editing various portions of a given interactive content dataset. In other embodiments, the content composition dialog 830 may be docked and remain open permanently.

In the depicted embodiment, the content composition dialog 830 includes a text entry region for entering or modifying the text for a section of the interactive content dataset. In some embodiments the text entry region may be displayed directly or may be shown and/or hidden by a tab element (not shown) of the content composition dialog 830. The content composition dialog 830 may also include a toolbar having formatting options for formatting the text entered in the text entry region and a user-selectable file attachment button labeled “Add an Attachment” which provides the user 122 the functionality of attaching or embedding additional and/or supplemental content. The content composition dialog 830 may also include user selectable buttons 831 for saving changes to the section, deleting the section, or canceling out of the content composition dialog 830.

With reference to FIG. 8J, in some embodiments, selecting the file attachment button labeled “Add an Attachment” in FIG. 8I opens a content attachment dialog 835 that includes options to add or link to various objects to the section of the dataset be added or edited. However, it should be understood that the content composition and attachment dialogs 730 and 835 are not limited to these embodiments and that other variations are possible and are included in the scope of the present disclosure. For example, the content attachment dialog 835 and content composition dialog 830 may be integrated into the same dialog.

The content attachment dialog 835 may provide a variety of tools and associated links and/or icons to facilitate adding, embedding or linking desirable content to a selected interactive content dataset. In the depicted embodiment, the content attachment dialog 835 includes a tab 836 for embedding a video viewing window for viewing a video stream or an attached video file, a tab 837 for embedding an audio playback window for playing an audio stream or an attached audio file, a tab 838 for embedding image files, a tab 839 for adding slide shows or other presentation files, such as a PowerPoint or Keynote files and the like, a tab 840 for creating and adding polls or surveys, and for obtaining associated data and participating in such polls or surveys, and/or a tab 841 for adding other electronic files, such as data files or other files created by an author, a user, or otherwise available from a third-party. The content attachment dialog 835 may also include other tabs including for addition other types of content and resources, such as spreadsheets, charts, graphs, tables, hypermedia, etc. In various embodiments, each of the secondary or ancillary content/files corresponding with or to tabs 836, 837, 838, 839, 840, and/or 841 may be formatted using any known suitable format compatible with the selected interactive content dataset the user 122 is contributing to or otherwise editing.

The secondary or ancillary content/files may be added to or otherwise embedded or linked with the underlying interactive content dataset to supplement, augment, or otherwise enhance the substance of the underlying dataset as a whole. By way of example and not limitation, embedded images 723 and/or audio/video files 721 (among other files associated with tabs/links 836, 837, 838, 839, 840, and/or 841) could be selected in order to support, depict, exemplify, illustrate or otherwise clarify the textual content of the dataset. In another example, a secondary or ancillary file could be selected to critique or otherwise provide another viewpoint relative to the content of a chosen interactive content dataset. In this way, additional or supplemental content/file(s) can enhance learning or educational capacity yielded by the dataset, or question the contents of the dataset and thereby contribute to a critical discussion or other critical thought in regard to the contents of the dataset. Secondary or ancillary content/files may also be selected in order to note something in the underlying dataset that may be of interest to the author, other readers, and/or other contributors. In these or other embodiments, additional sections may be added using the text editing and other content addition features of the content composition dialog 830 and/or content attachment dialog 835 to create a second edition of a former work, multiple editions of a text book, and so forth.

The secondary or ancillary content/files can enhance the underlying dataset beyond augmenting or adding to the substance of the underlying dataset itself. By way of example and not limitation, in some embodiments, audio files associated with tab 837 could be chosen to provide a translation of a given textual entry. Likewise, an audio file could be embedded to provide a pronunciation for difficult, new, or uncommon vocabulary words. In such embodiments, the author/user 122 is permitted to select an embedded audio clip directly next to the text which includes unfamiliar terms and/or text written in another language for assistance in reading and comprehending the text. In other embodiments, data files associated with tab 841 may be linked to the underlying dataset in order to provide a direct link to homework assignments, lesson plans, or other external assignments and/or resources associated with a given portion of the file, such as at the end of a section or chapter of a book. In still other embodiments, tab 840 can be used to craft and monitor a poll or survey in order to interactively solicit opinions and/or other information about the contents of a given file. In such embodiments, tab 840 may also permit the author of the poll or survey to graphically automate and/or display the results of the surveyor poll for the benefit of all users.

In some embodiment, when tab 840 is selected, the author/user 122 is provided with a dialog 850 having various options for creating a poll or survey as shown in FIG. 8K. A poll/survey enables the author and users alike to identify, receive and review select information pertaining to the underlying dataset being reviewed by others in real-time. The dialog 850 may include a question field 851, one or more answer fields 852 for defining user-selectable answers to the question, and graph options 853 for defining how to display the results of the survey/poll. The graph option 853 may include selectors for a vertical bar graph, horizontal bar graph, stacked column graph, a pie chart, etc. The dialog may also include elements for defining the duration of the poll (not shown), the subject or target audience intended for the poll (not shown), and so forth. In some embodiments, the author and other users 122 are permitted to view the results of the survey/poll in real-time as the poll develops or progresses. In other embodiments, the results of the poll/survey are not available until the poll or survey closes. While FIG. 8K only depicts elements for defining a single question with corresponding answers, other interfaces may include elements for defining multiple sets of questions and answers.

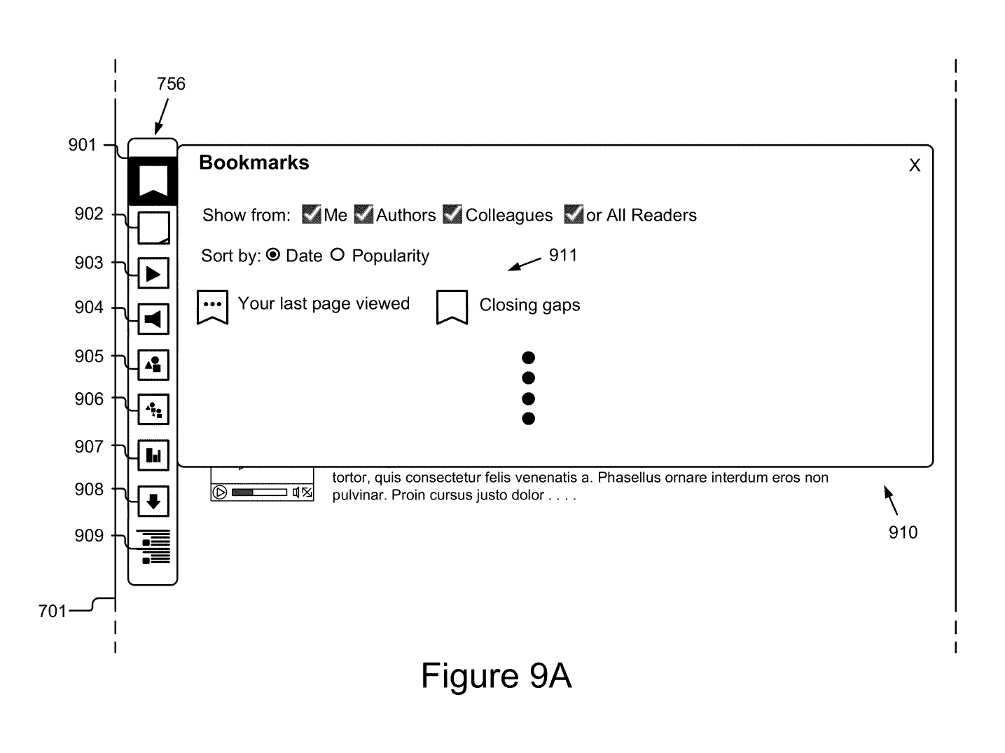

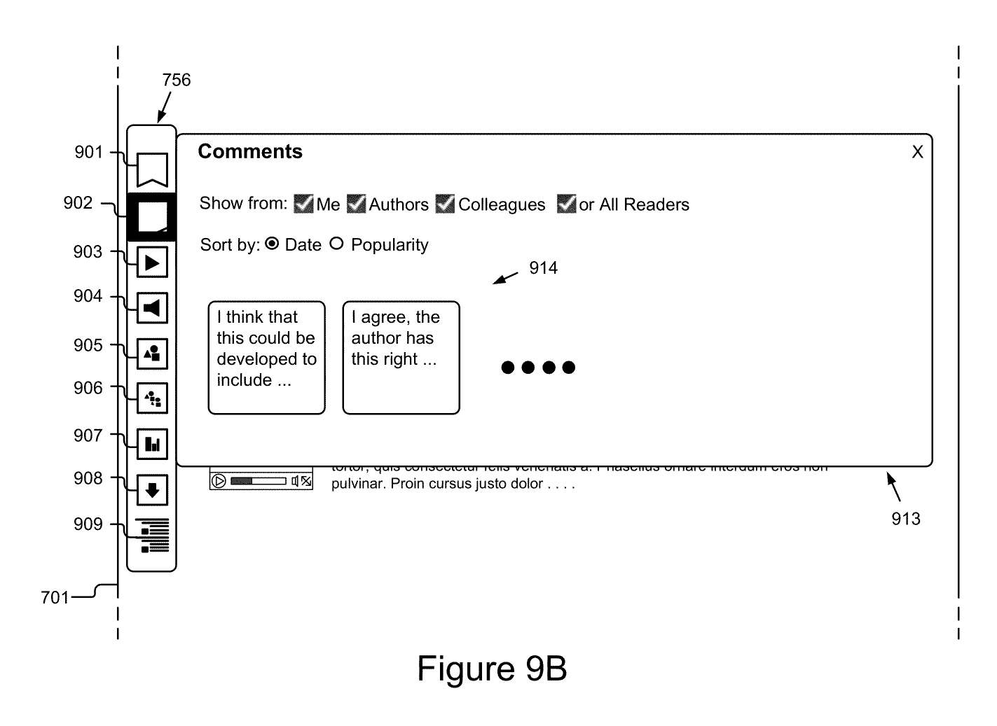

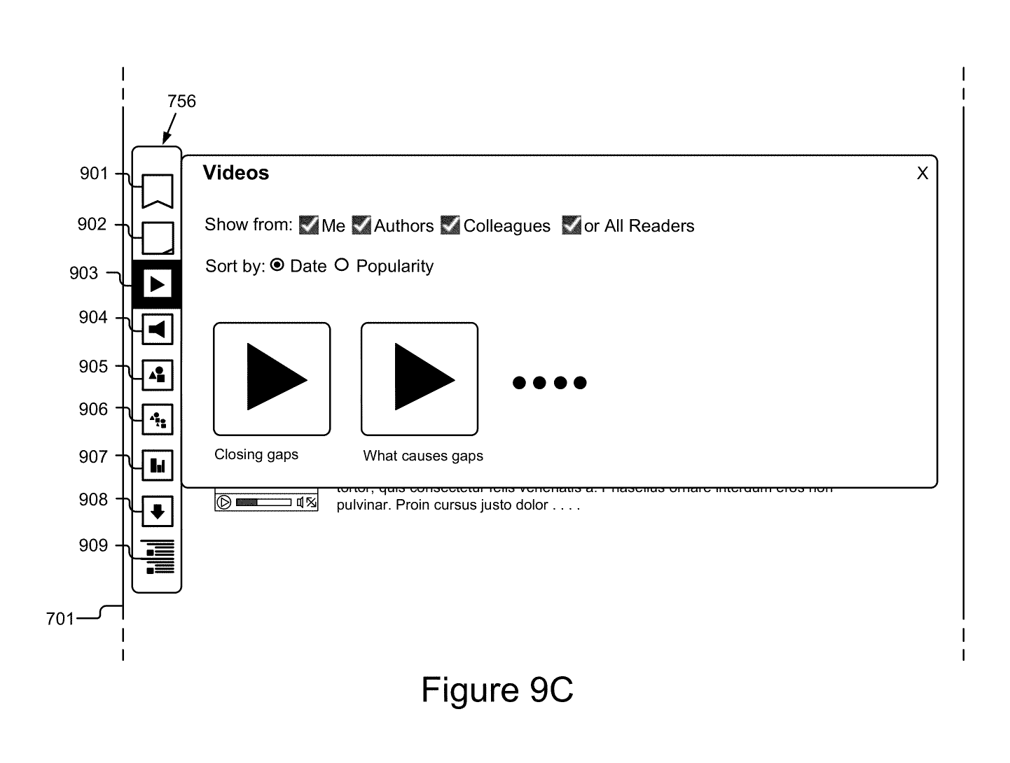

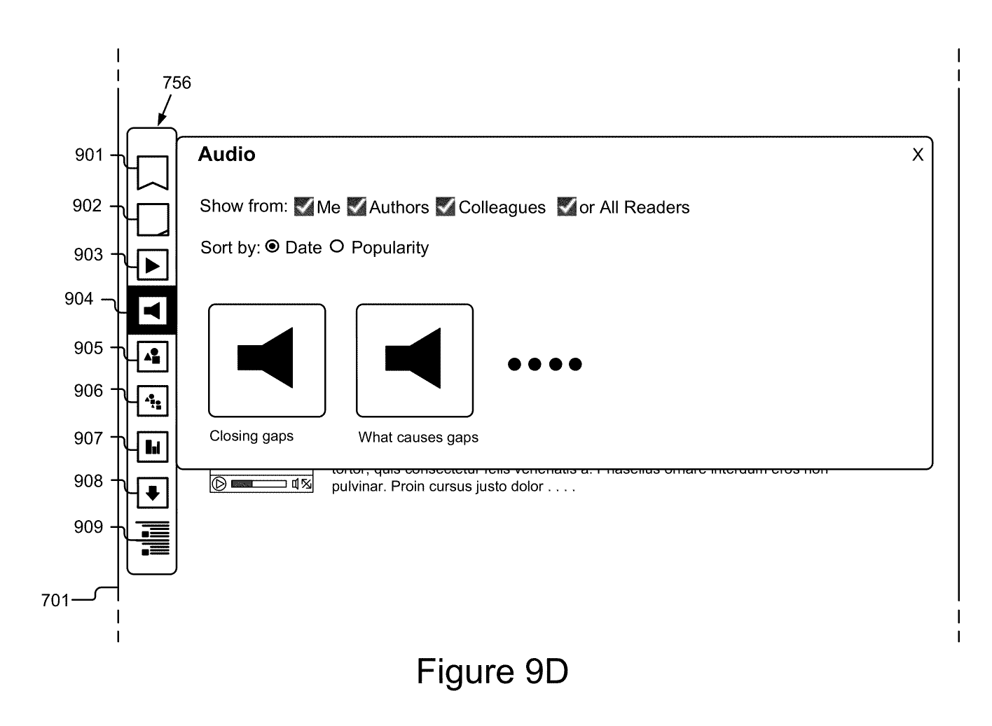

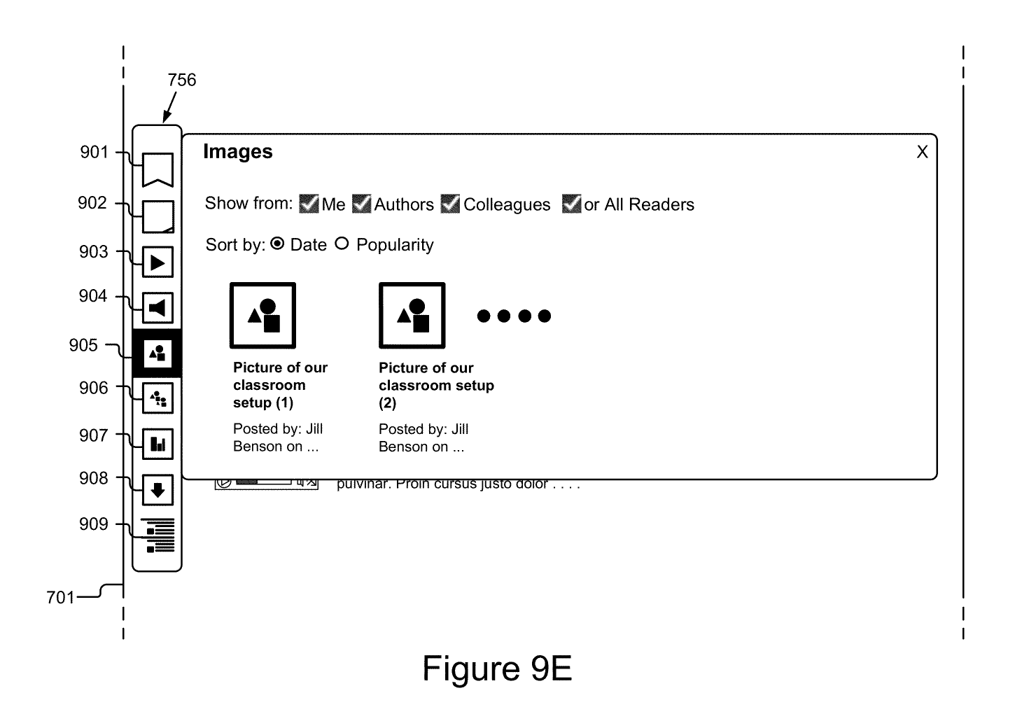

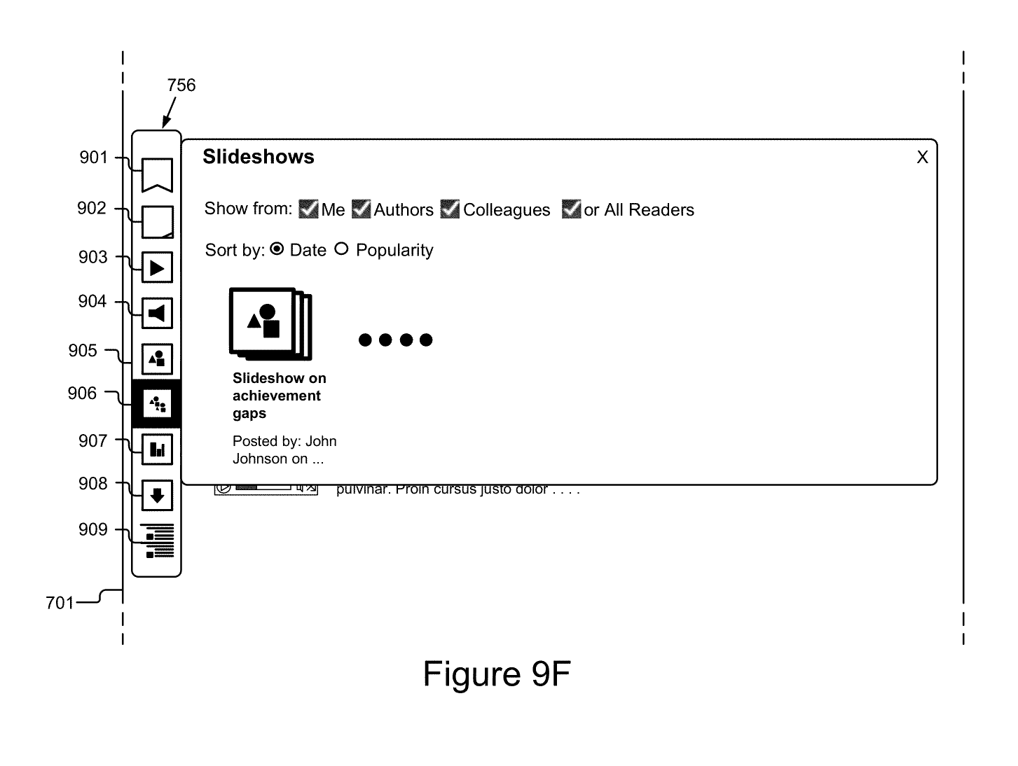

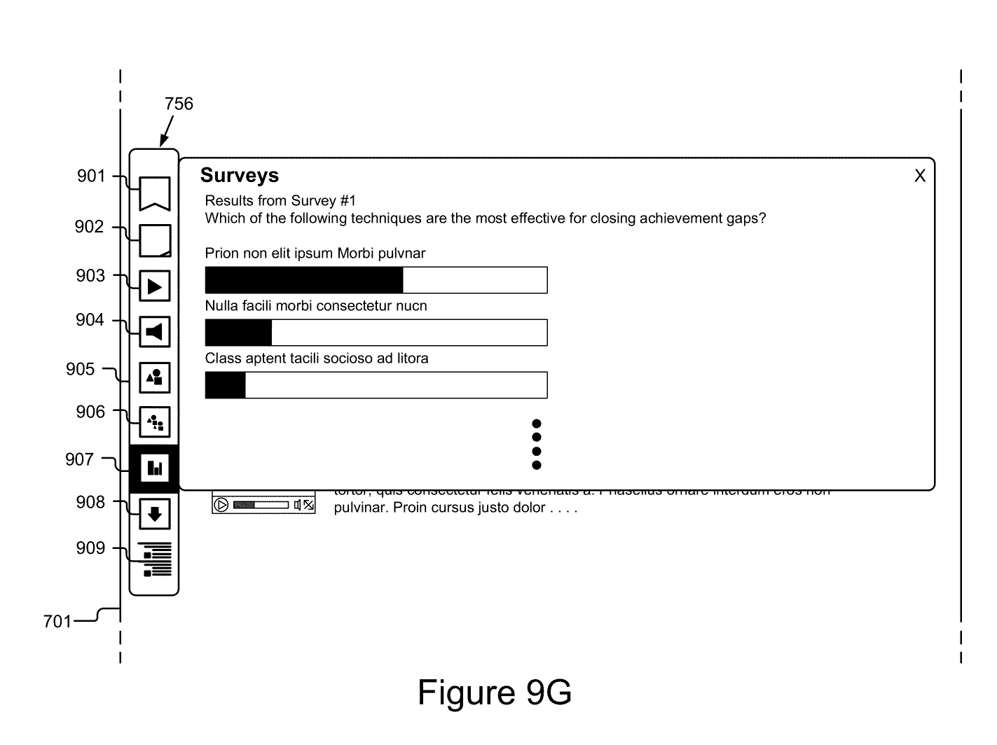

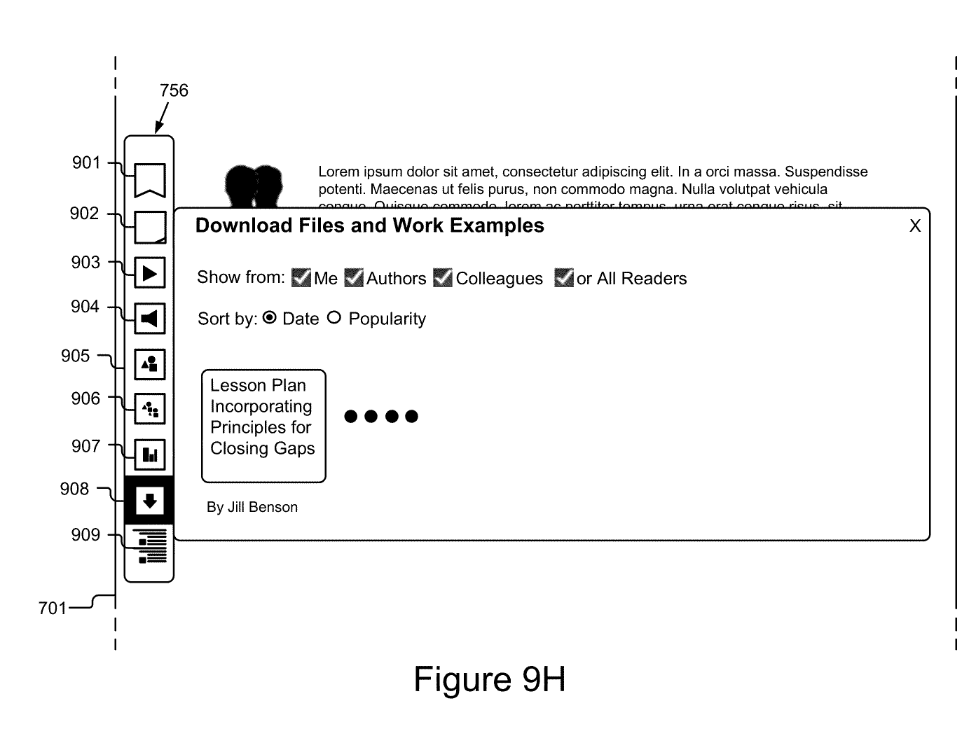

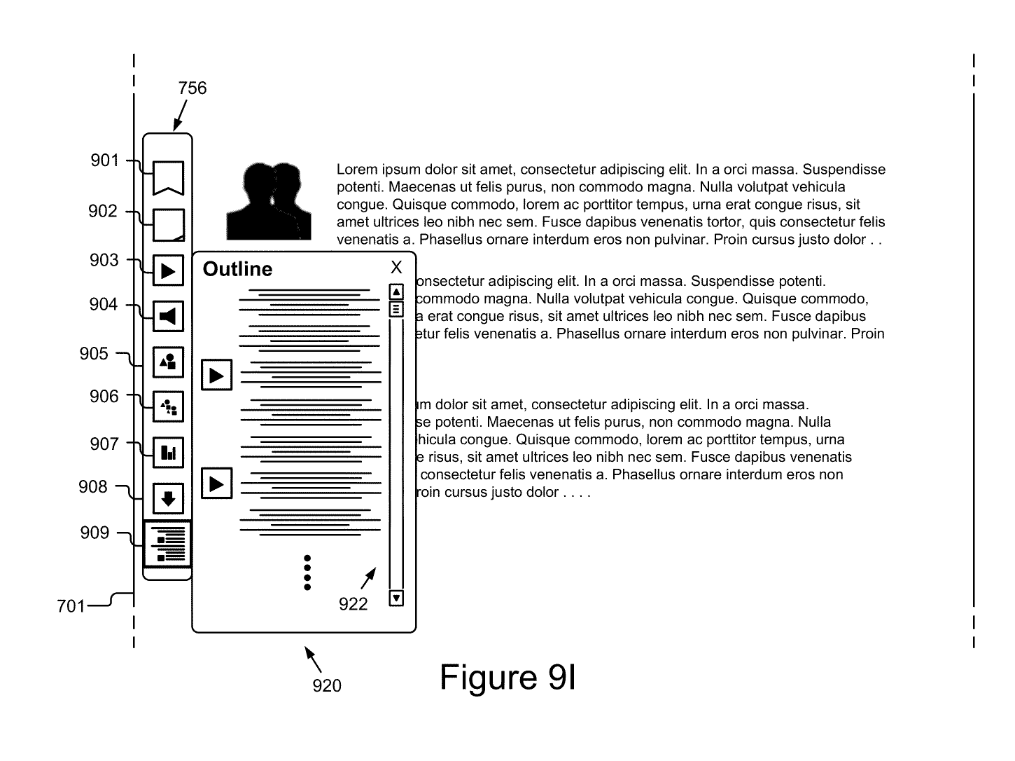

FIGS. 9A-9I are graphic representations that collectively describe features related to the navigation toolbar 756 for navigating the interactive content dataset and the user interactions therewith according to some embodiments. In some embodiments, the navigation toolbar 756 provides the user 122 viewing the interactive content dataset the ability to quickly and conveniently view various aspects of the dataset, such as bookmarks, videos, audio recordings, images, slide shows, surveys, file attachments, etc., without having to manually navigate/scroll/page through the entire interactive content dataset.

As depicted in at least FIG. 9A, the navigation toolbar 756 includes a bookmark navigation button 901, comment navigation button 902, a video navigation button 903, an audio navigation button 904, an image navigation button 905, a slideshow navigation button 906, a survey navigation button 907, a file download navigation button 908, and an outline button 909. In these or other embodiments, the navigation toolbar may be a vertically oriented sidebar that flanks the main content of the interactive content dataset, a horizontally oriented toolbar included in the main toolbar 706 (e.g., see FIG. 7A), combined with one or more other elements of the user interface 700, a hovering toolbar that follows the user gestures as the user moves about the window 701, a dockable toolbar that may be docked to an element of the window 701, a combination of the forgoing, etc. However, the navigation toolbar 756 is not limited to these embodiments, and may include additional or fewer navigation elements, may be ordered in a user-configurable manner, or may be configured by a user to add customized navigation elements. The navigation toolbar 756 may also include other navigation elements, one or more buttons for viewing all work examples, lesson plans, assignments, action items, etc. associated with the interactive content dataset, etc.

In some embodiments, the bookmark navigation button 902, when selected, may display a bookmark navigation dialog 910 including bookmarks 911 that have been set by the user 122, the author/user 122 and/or other users 122. In some embodiments, the data describing the bookmarks is provided by the application engine 104 and displayed by the client application 302 via the bookmark navigation dialog. In some embodiments, bookmarks 911 may be filtered by the client application 302 and/or the interactivity module 206 according to filter criteria to include and/or exclude content that does not meet the filter criteria. For example, the bookmarks 911 may be filtered to exclude bookmarks set by the author/user 122. In some embodiments, a bookmark may be created using the bookmarking functionality discussed above with reference to the interactivity toolbar 750, or may be auto generated by the client application 302 in cooperation with interactivity module 206. For example, a bookmark may be generated to identify the page or paragraph of the interactive content dataset last viewed by the user 122.

The comment navigation button 902, when selected, may initialize a comment navigation dialog 913 as shown in FIG. 9B for displaying comments 914 by users 122 pertaining to various aspects of the interactive content. In some embodiments, the comments appearing in the content navigation dialog were created using the comment creation functionality described above with reference to FIGS. 8A and 8B, for example. The comment navigation dialog includes filtering elements that are the same or similar to the filtering elements discussed above with reference to FIG. 8A, and thus, in the interest of brevity, the description of those filtering elements will not repeated here. In some embodiments, selection of a tile representing a comment may open a dialog for viewing, editing and/or deleting it, such as one similar to or the same as the comment addition dialog 802 depicted in FIG. 8B, provided user 122 has permission to do so. In some embodiments, users 122 and/or author/users 122 alike are permitted to see all comments created by other users. In other embodiments, various comments may be limited to a particular audience of users 122.

Similar to the bookmark navigation button 901 and the comment navigation button 902, the other buttons 903, 904, 905, 906, 907 and 908, when selected, may initialize respective navigation dialogs for displaying videos, audio recordings, images, slide shows, surveys, and downloadable files that are associated with the interactive content dataset, as illustrated by FIGS. 9C, 9D, 9E, 9F, 9G, and 9H. In some embodiments, the navigation dialogs are populated with content that is embedded in/annotated to the interactive content dataset by the author/user 122 using the functionality described with reference to at least FIGS. 8I-8K, and the user 122 may access or view the content by selecting it via the corresponding dialog. For example, with reference to the survey navigation dialog, a user 122 may view all surveys associated with the interactive content dataset, open a given survey, select his or her answer(s) to one or more survey queries, submit his or her answer, etc. In a further example, users 122 may also view the raw data underlying the poll or survey to either critique the poll/survey, build on the poll/survey, comment on the poll/surveyor otherwise use the poll/survey and/or the results thereof for the benefit of all authors and/or users with access to the same, using the survey navigation dialog. In these or other embodiments, the navigation dialogs may also be populated with content provided by user interaction with the content using the interactivity toolbar 750, for example via comments, discussions, file attachments, etc. In the foregoing embodiments, any functionality discussed above with reference to the navigation toolbar 756 and its associated dialogs, such as the filtering options discussed above with reference to the comment navigation dialog, are applicable to and may be included in any of the navigation dialogs.

In some embodiments, the outline button 909, when selected, initializes the display of outline dialog 920 depicting a high-level outline view of the interactive content dataset that provides a simplified way of navigating through the dataset, as illustrated by FIG. 8J. In some embodiments, the outline dialog may include a scroll region 922 for scrolling through the outline. A user 122 may select a sequence of lines representing a section of the interactive content dataset using the outline dialog and the client application 302 pages the content displayed in window 701 of the reader tab 709 to the corresponding section of the interactive content dataset. This provides the viewer/user 122 the benefit of easily navigating from section to section of the interactive content dataset without having to page through each page of the interactive content dataset. Additionally, the greyed-out sections depicted by the outline dialog conveniently inform an author/user 122 of sections of the interactive content dataset that have not yet been published.

It should also be understood that the user interfaces described in FIGS. 7A-10B are merely examples and that the interface elements may have a variety of distinct formats, positions within the window, and combinations, all of which are encompassed by the scope of the present disclosure.

The interactive professional development and/or educational experience provided by the user interfaces described herein yield many benefits including providing access to peers' thoughts, reflections and learning on various topics; providing collaborative and increasingly useful resources for addressing various work-related issues and challenges via the comments, updates, bookmarks, forum discussions, etc. associated with the datasets; reducing re-learning and loss of valuable lessons-learned by memorializing them via the interactive features of and real-time updates to the datasets; enabling user driven comments and interests; facilitating the formation of book study groups (both private and public via the social graph); providing a robust feedback loop to the author of a dataset regarding its content; etc. Additionally, with reference to corresponding inter-linked datasets, the forums, the wall, and the content sharing and other interactive features described herein can facilitate collaboration between educators to further enable them to turn the theory of a first dataset into practice using the functionality of a second dataset.

The examples and embodiments described herein are provided by way of example to provide a thorough understanding of the disclosure and should not be construed as limiting. It should be understood that variations of these examples and embodiments are contemplated and fall within the scope of this disclosure. Moreover, it should be understood that the technology described in the various example embodiments can be practiced without these specific details. In other instances, structures and devices were shown in block diagram form in order to avoid obscuring the disclosure. For example, the present disclosure was described in some embodiments above with reference to user interfaces and particular hardware. However, the present disclosure applies to any type of computing device that can receive data and commands, and any devices providing services, and it should be understood that the present disclosure applies to any type of network-based service including communication between endpoints.

Reference in the specification to “some embodiments” or “other embodiments” means that a particular feature, structure, or characteristic described in connection with the embodiment is included in at least one embodiment of the disclosure. The appearances of the phrase “in some embodiment” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, wireless adapters, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description above. In addition, the present disclosure is not described with reference to any particular programming language. It will be appreciated that a variety of programming languages may be used to implement the teachings of the disclosure as described herein.

It is intended that the scope of the disclosure be limited not by this detailed description, but rather by the claims of this application. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, it should be understood that the modules, routines, features, attributes, methodologies and other aspects of the disclosure can be implemented as software, hardware, firmware or any combination of the three. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
transmitting a first instance of an interactive content dataset via a network to a first client device of a first user for presentation;
receiving event data from the first client device via the network describing an interaction by the first user with the interactive content dataset, the interaction reflecting a learning activity being performed by the first user;
generating a report describing the interaction by the first user with the interactive content dataset; and
transmitting the report to one or more of the first client device of the first user and a second client device of a second user for presentation.

2. The computer-implemented method of claim 1, comprising:
performing an operation in connection with the interactive content dataset based on the interaction.

3. The computer-implemented method of claim 2, wherein the operation includes one of annotating a local instance of the interactive content dataset with supplemental information, sharing content from the interactive content dataset with another user, and updating a task associated with the interactive content dataset.

4. The computer-implemented method of claim 3, wherein the supplemental information includes one or more of a document attachment, poll results, survey results, a bookmark, a comment, a forum thread, input for a task or activity, and a user share.

5. The computer-implemented method of claim 1, comprising:
transmitting a first instance of a corresponding interactive content dataset that includes practical content and a user-completable task to the first client device for presentation; and
receiving event data describing a completion of the user-completable task from the first client device, wherein the interaction is a request for the corresponding interactive content dataset and the report is generated to include the completion of the user-completable task.

6. The computer-implemented method of claim 1, comprising:
annotating a local instance of the interactive content dataset with the interaction, the interaction being a comment by the first user about an aspect of the interactive content dataset;
transmitting a second instance of the interactive content dataset that includes the comment to a third client device of a third user via the network for presentation;
receiving event data from the third client device via the network describing a revision to the second instance of the interactive content dataset that corresponds to the comment; and
modifying the local instance of the interactive content dataset based on the revision.

7. The computer-implemented method of claim 1, comprising:
receiving a report request via the network from the second client device, wherein the report is generated responsive to the receiving of the report request and the report is transmitted to the second client device for presentation.

8. The computer-implemented method of claim 1, comprising:
generating a work-product for the first user based on the interaction; and
transmitting the work-product to the first client device for presentation, wherein the interaction describes a task completed by the user.

9. The computer-implemented method of claim 1, comprising:
determining a standing for the first user; and
personalizing a content of the first instance of the interactive content dataset to the first user based on the standing.

10. The computer-implemented method of claim 1, comprising:
receiving event data from a plurality of client devices associated with a plurality of users, respectively; and
personalizing a content of the first instance of the interactive content dataset to the first user based on the event data received from the plurality of client devices.

11. A computer program product comprising a computer usable medium including instructions which, when executed by a computer, cause the computer to:
transmit a first instance of an interactive content dataset via a network to a first client device of a first user for presentation;
receive event data from the first client device via the network describing an interaction by the first user with the interactive content dataset, the interaction reflecting a learning activity being performed by the first user;
generate a report describing the interaction by the first user with the interactive content dataset; and
transmit the report to one or more of the first client device of the first user and a second client device of a second user for presentation.

12. The computer program product of claim 11, wherein the instructions further cause the computer to:
perform an operation in connection with the interactive content dataset based on the interaction.

13. The computer program product of claim 12, wherein the operation includes one of annotating a local instance of the interactive content dataset with supplemental information, sharing content from the interactive content dataset with another user, and updating a task associated with the interactive content dataset.

14. The computer program product of claim 13, wherein the supplemental information includes one or more of a document attachment, poll results, survey results, a bookmark, a comment, a forum thread, input for a task or activity, and a user share.

15. The computer program product of claim 11, wherein the instructions further cause the computer to:
transmit a first instance of a corresponding interactive content dataset that includes practical content and a user-completable task to the first client device for presentation; and
receive event data describing a completion of the user-completable task from the first client device, wherein the interaction is a request for the corresponding interactive content dataset and the report is generated to include the completion of the user-completable task.

16. The computer program product of claim 11, wherein the instructions further cause the computer to:
annotate a local instance of the interactive content dataset with the interaction, the interaction being a comment by the first user about an aspect of the interactive content dataset;
transmit a second instance of the interactive content dataset that includes the comment to a third client device of a third user via the network for presentation;
receive event data from the third client device via the network describing a revision to the second instance of the interactive content dataset that corresponds to the comment; and
modify the local instance of the interactive content dataset based on the revision.

17. The computer program product of claim 11, wherein the instructions further cause the computer to:
receive a report request via the network from the second client device, wherein the report is generated responsive to the receiving of the report request and the report is transmitted to the second client device for presentation.

18. The computer program product of claim 11, wherein the instructions further cause the computer to:
generate a work-product for the first user based on the interaction; and
transmit the work-product to the first client device for presentation, wherein the interaction describes a task completed by the user.

19. The computer program product of claim 11, wherein the instructions further cause the computer to:
determine a standing for the first user; and
personalize a content of the first instance of the interactive content dataset to the first user based on the standing.

20. The computer program product of claim 11, wherein the instructions further cause the computer to:
receive event data from a plurality of client devices associated with a plurality of users, respectively; and
personalize a content of the first instance of the interactive content dataset to the first user based on the event data received from the plurality of client devices.

21. A system comprising:
one or more processors;
a communication unit for sending and receiving data over a network;
a content management engine executable by the one or more processors to transmit a first instance of an interactive content dataset via the communication unit to a first client device of a first user for presentation;
an interactivity module executable by the one or more processors to receive event data describing an interaction with the interactive content dataset from the first client device via the communication unit, the interaction reflecting a learning activity being performed by the first user; and
a reporting module executable by the one or more processors to generate a report describing the interaction by the first user with the interactive content dataset, and to transmit the report via the communication unit to one or more of the first client device and a second client device of a second user for presentation.

22. The system of claim 21, comprising:
a datastore for storing a local instance of the interactive content dataset, wherein the interactivity module is further configured to perform an operation in connection with the local instance of the interactive content dataset stored in the datastore based on the interaction.

23. The system of claim 22, wherein the operation includes one of annotating a local instance of the interactive content dataset with supplemental information, sharing content from the interactive content dataset with another user, and updating a task associated with the interactive content dataset.

24. The system of claim 23, wherein the supplemental information includes one or more of a document attachment, poll results, survey results, a bookmark, a comment, a forum thread, input for a task or activity, and a user share.

25. The system of claim 21, wherein
the content management engine is further configured to transmit, via the communication unit, a first instance of a corresponding interactive content dataset that includes practical content and a user-completable task to the first client device for presentation,
the interactivity module is further configured to receive event data describing a completion of the user-completable task from the first client device,
the interaction is a request for the corresponding interactive content dataset, and
the report is generated to include the completion of the user-completable task.

26. The system of claim 21, comprising:
a datastore for storing a local instance of the interactive content dataset, wherein the interaction is a comment by the first user about an aspect of the interactive content dataset and the interactivity module is further configured to
annotate the local instance of the interactive content dataset stored in the datastore with the comment,
transmit a second instance of the interactive content dataset that includes the comment via the communication unit to a third client device of a third user for presentation,
receive event data from the third client device via the communication unit describing a revision to the second instance of the interactive content dataset that corresponds to the comment, and
modify the local instance of the interactive content dataset stored in the datastore based on the revision.

27. The system of claim 21, wherein the reporting module is further configured to receive a report request via the communication unit from the second client device, generate the report responsive to receiving the report request, and transmit the report to the second client device for presentation.

28. The system of claim 21, wherein the interactivity module is further configured to generate a work-product for the first user based on the interaction and to transmit the work-product to the first client device via the communication unit for presentation, wherein the interaction describes a task completed by the user.

29. The system of claim 21, wherein the content management engine is further configured to determine a standing for the first user and personalize a content of the first instance of the interactive content dataset to the first user based on the standing.

30. The system of claim 21, wherein the interactivity module is further configured to receive, via the communication unit, event data from a plurality of client devices associated with a plurality of users, respectively, and the content management engine is further configured to personalize a content of the first instance of the interactive content dataset to the first user based on the event data received from the plurality of client devices.
